(19) United States
(12) Patent Application Publication
(10) Pub. No.: US 2023/0017197 A1
(43) Pub. Date: Jan. 19, 2023

(54) RESIN FILM, METHOD FOR PRODUCING RESIN FILM, AND DISPLAY APPARATUS

(71) Applicant: SAMSUNG ELECTRONICS CO., LTD., Suwon-si (KR)

(72) Inventors: Yuichiro GOTO, Yokohama-shi (JP); Yoshihiro YOKOTE, Yokohama-shi (JP)

(21) Appl. No.: 17/941,185

(22) Filed: Sep. 9, 2022

Related U.S. Application Data
(63) Continuation of application No. PCT/KR2022/007543, filed on May 27, 2022.

(30) Foreign Application Priority Data
May 27, 2021 (JP) 2021-089426

(51) Int. Cl. G02F 1/1335; B29D 11/00

(52) U.S. Cl. CPC G02F 1/133502; G02F 1/133504; B29D 11/00788; B29D 11/00865; G02F 1/133528; B29K 2105/165

(57) ABSTRACT

Resin films and the like capable of improving viewing angle characteristics and antireflection characteristics, for example, when the resin film is applied to a display are provided. The resin film includes a low-refractive-index layer 17 and an anisotropic diffusion layer 16. The low-refractive-index layer 17 has a refractive index of 1.40 or less. The anisotropic diffusion layer 16 anisotropically diffuses light. The anisotropic diffusion layer 16 contains anisotropic particles 162 and a resin portion 161. The anisotropic particles 162 have an anisotropic shape and a longitudinal direction aligned along one direction. The resin portion 161 diffuses the anisotropic particles 162 and is formed of a resin. A reflectivity of the resin film excluding a specular reflection light component is 1.0% or less.

### CROSS-REFERENCE TO RELATED APPLICATION(S)

This application is bypass continuation application of International Application No. PCT/KR2022/007543, filed on May 27, 2022, which is based on and claims priority to Japanese Patent Application No. 2021-089426, filed on May 27, 2021, in the Japanese Intellectual Property Office, the disclosure of which is incorporated by reference herein in its entirety.

### BACKGROUND

### 1. Field

The present disclosure relates to a resin film and the like. More particularly, the present disclosure relates to a resin film and the like provided on a surface of a display means of a display apparatus.

### 2. Description of Related Art

Display apparatuses such as liquid crystal displays (LCD) or plasma display panels (PDP) have been known. In addition, display apparatuses such as an electroluminescence display (ELD) or a field emission display (FED) have been known. Typically, an antireflection film or an anti-glare film having a low-refractive-index layer is provided on an image display surface of these display apparatuses. The reflection of an observer or a background and the like of the observer is suppressed by the low-refractive-index layer.

The low-refractive-index layer is normally provided on an outermost surface of the antireflection film. Reflective lights from the low-refractive-index layer and an interface between the low-refractive-index layer and a lower layer are mutually canceled, thereby reducing the reflected light and suppressing reflection.

In a liquid crystal display, due to its image display principle, image quality when observed in an oblique direction (viewing angle characteristics) tends to be deteriorated, compared to other image display apparatuses. Specifically, a luminance or a contrast ratio when being observed in the oblique direction may be significantly reduced, compared to viewing the same from a front observation.

Recently, a method for enhancing the viewing angle characteristics of a liquid crystal display have been developed by applying a diffusion layer for diffusing image light.

One such prior development is disclosed in Japanese Laid-open Patent Application Publication No. 2003-114304. This document discloses an antireflection film. This antireflection film includes at least one light diffusion layer on a transparent base material. In the antireflection film including at least one layer of low-refractive-index layer thereon, the light diffusion layer has a haze value of 40% or more. The low-refractive-index layer is formed of a cured material of a thermosetting or an ionizing radiation-curable fluororesin. In addition, an average value of specular reflectivity at 5 degree incidence in a wavelength area of 450 nm to 650 nm is 2.5% or less.

Another such development is disclosed in Japanese Laid-open Patent Application Publication No. 2020-16881. This document discloses an optical structure. This optical structure is disposed on a lower portion of an antireflection film. This optical structure may include a low-refractive-index layer and a high-refractive-index layer. An interface between the low-refractive-index layer and the high-refractive-index layer forms an unevenness shape. A recess of the unevenness shape is recessed to a side of the low-refractive-index layer. A protrusion may be protruded to a side of the high-refractive-index layer. Each of the recess and the protrusion has a flat portion which extends along a plane direction of the low-refractive-index layer and the high-refractive-index layer. A shape that two adjacent side surfaces with the flat portion of the recess interposed therebetween are tapered toward the side of the low-refractive-index layer is formed on the side surface having the unevenness shape. A shape that two adjacent side surfaces with the flat portion of the protrusion interposed therebetween are tapered toward the side of the high-refractive-index layer is formed. The high-refractive-index layer is disposed to face the side of the display surface of the display apparatus. The image light is diffused in a specific direction by using refraction and diffraction on an interface of unevenness structure having a difference in refractive index.

Another such development is disclosed in Japanese Laid-open Patent Application Publication No. 2004-258105. This document discloses an anisotropic light diffusion adhesive laminate. This anisotropic light diffusion adhesive laminate is an adhesive laminate including two or more adhesive layers containing an adhesive. At least one layer of the adhesive layers contains an acicular filler having a refractive index different from that of the adhesive. The acicular filler is dispersed to be aligned in substantially the same direction. In addition, this anisotropic light diffusion adhesive laminate may include two layers of adhesive layers having different alignment directions of the acicular filler.

### SUMMARY

In the method for applying the light diffusion layer, the image light is diffused isotropically, and accordingly, a luminance and a contrast ratio at the time of front observation may be significantly decreased.

In a method for forming the unevenness shape of an interface between the low-refractive-index layer and the high-refractive-index layer, it is necessary to use an expensive film to which a fine structure is transferred. In addition, because it is necessary to bond the film having the unevenness shape to a display, this causes an increase in number of essential members and complicated producing step(s). Further, even when external light, such as illumination, is incident, color breakup occurs due to diffraction due to the unevenness shape, and iridescent unevenness may be visible on the display.

In addition, in the method for using an anisotropic light diffusion adhesive laminate, light diffusion biased in a specific direction may be achieved by blending the acicular filler in an adhesive resin. By applying these in the display, an angle of visibility may be increased. However, it is necessary to provide an adhesive layer having a relatively high light diffusion property in the display. Accordingly, this easily causes a decrease in luminance or contrast ratio of the display in a front direction. In addition, the increase in number of essential members and complicated producing step(s) also causes an increase in production cost(s). Further, an effect of light scattering from the adhesive layer when external light is incident is great. Although the antireflection film is provided, reflectivity of a display surface is not decreased and the display is seen with whiteness.

An object of the present disclosure is to provide a resin film capable of improving visible angle characteristics and antireflection characteristics, when the resin film is applied to a display, for example.

A resin film of the present disclosure includes a low-refractive-index layer and an anisotropic diffusion layer. The low-refractive-index layer has a refractive index of 1.40 or less. The anisotropic diffusion layer anisotropically diffuses light. In addition, the anisotropic diffusion layer includes anisotropic particles and a resin portion. The anisotropic particles have an anisotropic shape with a longitudinal direction aligned along one direction. The resin portion diffuses the anisotropic particles and is formed of a resin. A reflectivity of the resin film excluding a specular reflection light component is 1.0% or less.

Here, the anisotropic particles may have a refractive index in the longitudinal direction and a refractive index in a short direction different from each other. It will be appreciated that the short direction may be normal or perpendicular to the longitudinal direction.

In addition, a refractive index of the resin portion is defined as n_{b}. The refractive index of the anisotropic particles in the longitudinal direction is defined as nₐₓ. The refractive index of the anisotropic particles in the short direction is defined as n_{ay}. In this case, at least one of the following relationships (I) and (II) is satisfied:

|n_{b}−nₐₓ|<0.04 and 0.04<|n_{b}−n_{ay}|<0.50 Relationship (I):

|n_{b}−n_{ay}|<0.04 and 0.04<|n_{b}−nₐₓ|<0.50 Relationship (II):

The anisotropic particles may have a length in the longitudinal direction of 1 μm to 200 μm. In addition, the anisotropic particles may have a length in the short direction of 0.1 μm to 10 μm.

An aspect ratio, which is a ratio of the length of the anisotropic particles in the longitudinal direction compared to the length in the short direction, may be 10 or more.

An interface between the anisotropic particles and the resin portion may be compatible.

The refractive index of the resin portion may be 1.45 to 1.65.

The anisotropic particles may contain at least one of metal oxide, a carbonate compound, a hydroxide compound, and a phosphate compound.

A difference in refractive index of the resin portion and the low-refractive-index layer may be 0.1 or more.

The anisotropic diffusion layer may have a haze value of 20% to 80%.

The anisotropic diffusion layer may have an anisotropic diffusivity of 3 or more.

The resin film may further include a high-refractive-index layer having a refractive index of 1.60 or more.

The resin film may further include a hard coating layer having a refractive index of 1.54 or more.

The resin film may further include a base material which supports the low-refractive-index layer and the anisotropic diffusion layer. This base material is provided between the low-refractive-index layer and the anisotropic diffusion layer.

The anisotropic diffusion layer may function as a base material which supports the low-refractive-index layer.

A method for producing a resin film of the present disclosure includes a low-refractive-index layer producing step and an anisotropic diffusion layer producing step. In the low-refractive-index layer producing step, a low-refractive-index layer having a refractive index of 1.40 or less is produced. In the anisotropic diffusion layer producing step, an anisotropic diffusion layer which anisotropically diffuses light is produced. The anisotropic diffusion layer comprises anisotropic particles and a resin portion. The anisotropic particles have an anisotropic shape and a longitudinal direction is aligned along one direction. The resin portion diffuses the anisotropic particles and is formed of a resin. A reflectivity of the resin film excluding a specular reflection light component is 1.0% or less.

The anisotropic diffusion layer may be a base material which supports the low-refractive-index layer. In this case, in the low-refractive-index layer producing step, the low-refractive-index layer is formed on the base material.

The anisotropic diffusion layer may be produced by stretching.

The display apparatus of the present disclosure includes display means for displaying an image and the resin film provided on a surface of the display means.

An optical member of the present disclosure includes a base material and the resin film provided on the base material.

A polarizing member of the present disclosure includes a polarizing means for polarizing light and the resin film provided on the polarizing means.

According to the present disclosure, for example, it is possible to provide a resin film and the like capable of improving viewing angle characteristics and antireflection characteristics of a display, when the resin film is applied to the display.

### BRIEF DESCRIPTION OF THE DRAWINGS

The above and other advantages and features of this disclosure will become more apparent by describing in further detail embodiments thereof with reference to the accompanying drawings, in which:

FIG. 1 is a diagram illustrating a display apparatus to which the present embodiment is applied.

FIG. 2 is a cross-sectional view of FIG. 1 as viewed along the line 1b-1b, and illustrates an example of a configuration of a liquid crystal panel to which the present embodiment is applied.

FIG. 3 is a diagram illustrating a base material, an anisotropic diffusion layer, and a low-refractive-index layer.

FIG. 4 is a diagram illustrating the anisotropic diffusion layer.

FIG. 5 is a diagram illustrating the anisotropic diffusion layer.

FIG. 6 is a diagram illustrating the anisotropic diffusion layer.

FIG. 7 is a diagram illustrating an example of a configuration of a resin film.

FIG. 8 is a diagram illustrating an example of a configuration of a resin film.

FIG. 9 is a diagram illustrating an example of a configuration of a resin film.

FIG. 10 is a diagram illustrating an example of a configuration of a resin film.

FIG. 11 is a diagram illustrating an example of a configuration of a resin film.

FIG. 12 is a diagram illustrating an example of a configuration of a polarizing plate to which an embodiment is applied.

FIG. 13 is a diagram illustrating an example of a configuration of a polarizing plate to which an embodiment is applied

FIG. 14 is a flowchart illustrating a method for producing a resin film having a layer structure illustrated in FIG. 3.

FIG. 15 is a flowchart illustrating a method for producing an anisotropic diffusion layer and a low-refractive-index layer.

### DETAILED DESCRIPTION

Hereinafter, example embodiments for practicing the present disclosure will be described in detail. The present disclosure is not limited to the following embodiments. In addition, various modifications may be performed within the scope of the present disclosure even when not explicitly shown or described. The accompanying drawings are for describing the embodiments of the present disclosure and do not show actual sizes.

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third,” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “first component,” “first region,” “first layer,” or “first section” discussed below could be termed a second element, component, region, layer, or section without departing from the teachings herein.

The terminology used herein is for the purpose of describing particular embodiments only and is not intended to be limiting. As used herein, “a,” “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the figures. It will be understood that relative terms are intended to encompass different orientations of the device in addition to the orientation depicted in the figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein are inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

<Description of Display Apparatus>

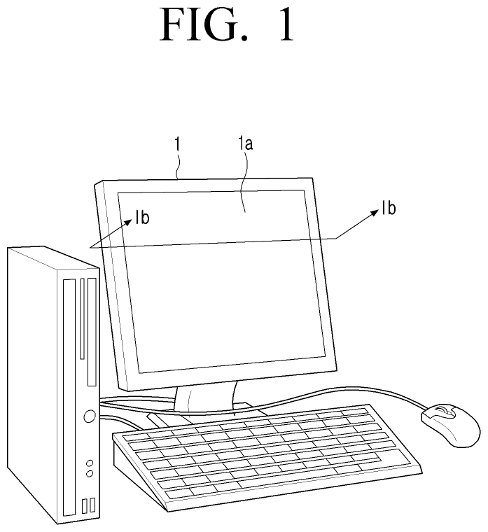

FIG. 1 is a diagram illustrating a display apparatus 1 to which embodiment described herein may be applied.

The display apparatus 1 illustrated in the drawing may be, for example, a liquid crystal display for a personal computer, a liquid crystal television, or the like. The display apparatus 1 displays an image on a liquid crystal panel 1a.

<Description of Liquid Crystal Panel 1a>

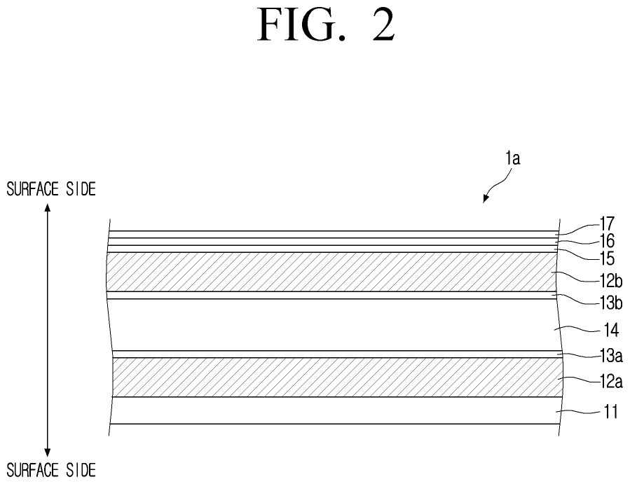

FIG. 2 is a cross-sectional view of the display apparatus 1 shown in FIG. 1 viewed along the line 1b-1b and illustrates an example of a configuration of the liquid crystal panel 1a to which embodiments disclosed herein may be applied.

The liquid crystal panel 1a is an example of display means for displaying an image. The liquid crystal panel 1a of the present embodiment may be, for example, a vertical alignment (“VA”) type liquid crystal panel. The liquid crystal panel 1a illustrated in the drawing includes a backlight 11 and a polarizing film 12a. In addition, the liquid crystal panel 1a includes a retardation film 13a, a liquid crystal 14, a retardation film 13b, and a polarizing film 12b. Further, the liquid crystal panel 1a includes a base material 15, an anisotropic diffusion layer 16, and a low-refractive-index layer 17. The films and layers 11, 12a, 13a, 14, 13b, 12b, 15, 16, 17 form a structure in which the films/layers are laminated in this order from an inner side to a surface side. Hereinafter, the polarizing film 12a and the polarizing film 12b may be referred to simply as a polarizing film 12, if these are not distinguished. In the present embodiment, a laminate of the anisotropic diffusion layer 16 and the low-refractive-index layer 17 is an example of a resin film. In addition, a laminate of the base material 15, the anisotropic diffusion layer 16, and the low-refractive-index layer 17 is also an example of a resin film.

The backlight 11 emits light to the liquid crystal 14. The backlight 11 is, for example, a cold cathode fluorescent lamp or a white light emitting diode (“LED”).

The polarizing film 12a and the polarizing film 12b are an example of polarizing means for polarizing light. The polarizing film 12a and the polarizing film 12b have polarizing directions orthogonal to each other. The polarizing film 12a and the polarizing film 12b, for example, includes a resin film in which poly-vinyl alcohol (PVA) contains iodine compound particles. The polarizing films are obtained by bonding and sandwiching with a resin film formed of triacetylcellulose (TAC). The light is polarized by containing the iodine compound particles.

The retardation films 13a and 13b compensate viewing angle dependency of the liquid crystal panel 1a. The light that has passed through the liquid crystal 14 changes its polarizing state from linear polarization to elliptical polarization. For example, in a case of black display, the liquid crystal panel 1a looks black, when it is seen in a vertical direction. Meanwhile, when the liquid crystal panel 1a is seen in an oblique direction, retardation of the liquid crystal 14 occurs. In addition, an axis of the polarizing film 12 is not 90°. Accordingly, light leakage occurs and a problem of a decrease in contrast occurs. In other words, the viewing angle dependency occurs in the liquid crystal panel 1a. The retardation films 13a and 13b have a function of returning this elliptical polarization to the linear polarization. Accordingly, the retardation films 13a and 13b may compensate the viewing angle dependency of the liquid crystal panel 1a.

A power supply (not illustrated) is connected to the liquid crystal 14. When a voltage is applied from the power supply, an alignment direction of the liquid crystal 14 changes. Accordingly, the liquid crystal 14 controls a transmission state of light.

In a case of a VA type liquid crystal panel, when the voltage is not applied to the liquid crystal 14 (voltage OFF), liquid crystal molecules are aligned in a perpendicular direction in the drawing. When light is emitted from the backlight 11, first, the light passes through the first polarizing film 12a and changed into polarized light. The polarized light passes through the liquid crystal 14 as it is. The second polarizing film 12b has a different polarizing direction, and accordingly, this polarized light is blocked. In this case, a user who is watching the liquid crystal panel 1a may not visually recognize this light. In other words, in a state where the voltage is not applied to the liquid crystal 14, the color of the liquid crystal is “black”.

In contrast, when a maximum voltage is applied to the liquid crystal 14, the liquid crystal molecules are aligned in a horizontal direction in the drawing. A direction of polarization of the polarized light which has passed through the first polarizing film 12a rotates 90 degrees by the action of the liquid crystal 14. Accordingly, the second polarizing film 12b does not block but transmits this polarized light. In this case, the user who is watching the liquid crystal panel 1a may visually recognize this light. In other words, in a state where the maximum voltage is applied to the liquid crystal 14, the color of the liquid crystal is “white”. In addition, the voltage may also be between the voltage OFF and the maximum voltage. In this case, the liquid crystal 14 is between a vertical direction in the drawing and a direction perpendicular to the vertical direction in the drawing. In other words, the liquid crystal 14 is aligned in an oblique direction which is a direction intersecting both of the vertical direction and the perpendicular direction. In this state, the color of the liquid crystal is “gray”. Accordingly, by adjusting the voltage applied to the liquid crystal 14 from OFF to the maximum voltage, intermediate gradation may be expressed in addition to black and white. Thus, an image is displayed.

Although not illustrated in the drawing, a color image may also be displayed using one or more color filters.

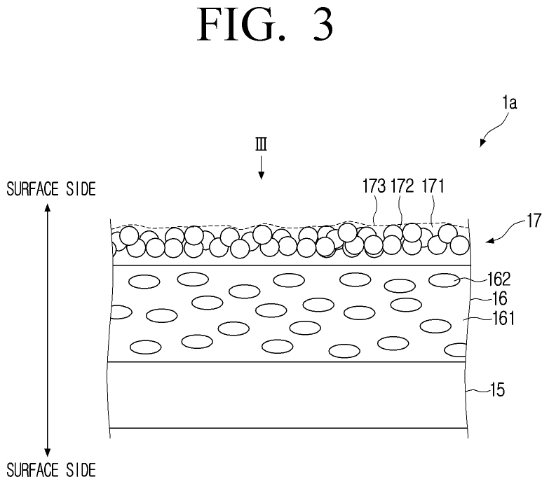

FIG. 3 is a diagram illustrating the base material 15, the anisotropic diffusion layer 16, and the low-refractive-index layer 17.

Here, in the drawing, an upper side is a surface side of the liquid crystal panel 1a and a lower side is an inner side of the liquid crystal panel 1a.

The base material 15 is a support for forming the anisotropic diffusion layer 16 and the low-refractive-index layer 17. The base material 15 is preferably a transparent base material having a total light transmittance of 85% or more. For the base material 15, for example, triacetylcellulose (TAC) described above may be used. In addition, this is not limited thereto and polyethylene terephthalate (PET) or the like may also or alternatively be used. However, in the present embodiment, triacetylcellulose (TAC) may be suitably used. The base material 15 may have a thickness of, for example, 20 μm to 200 μm.

The anisotropic diffusion layer 16 anisotropically diffuses light. Here, “anisotropic diffusion” is a property having a strong light diffusion property in a specific direction. The “anisotropic diffusion layer” is a diffusion layer having a strong light diffusion property in a specific direction. When a member, including the anisotropic diffusion layer, is irradiated with isotropic light (circular shape) such as laser light, the transmitted light thereof has a linear shape or an elliptical shape.

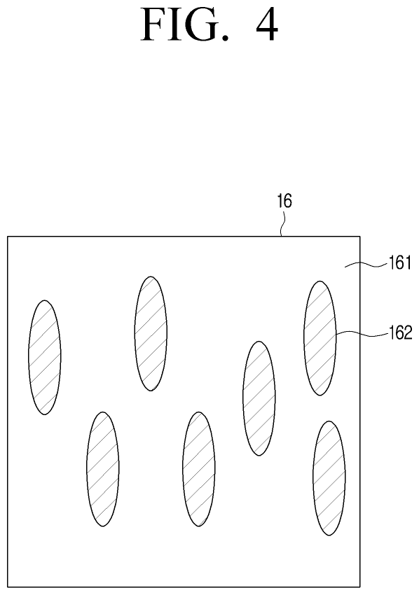

FIGS. 4-6 are diagrams illustrating the anisotropic diffusion layer 16.

Among these, FIG. 4 is a diagram in which the anisotropic diffusion layer 16 is seen in the direction III of FIG. 3 (i.e., viewed toward a surface of the low-refractive-index layer 17).

Referring to FIGS. 3 and 4, the anisotropic diffusion layer 16 includes at least a resin portion 161 and anisotropic particles 162 embedded or dispersed within the resin portion 161.

The resin portion 161 diffuses the anisotropic particles 162 and is formed of a resin. Accordingly, the resin portion 161 may also be referred to as a dispersion layer for fixing the anisotropic particles 162 so that a longitudinal direction is aligned along one direction.

The anisotropic particles 162 have an anisotropic shape and the longitudinal direction thereof is aligned along one direction in the resin portion 161, as illustratively shown in FIG. 4. In this case, referring to FIG. 3, the longitudinal direction of the anisotropic particles 162 is aligned in an in-plane direction of the anisotropic diffusion layer 16. In addition, in this case, referring to FIG. 4, the longitudinal direction thereof is aligned along the vertical direction in the drawing.

The resin portion 161 is formed of a resin, as described above. A refractive index of the resin portion 161 is preferably 1.45 to 1.65. A specular component excluded (“SCE”), which is a reflectivity of the anisotropic diffusion layer 16 excluding a specular reflection light component, is necessarily 1.0% or less. That is, when the refractive index of the resin portion 161 is in this range (i.e., 1.45 to 1.65), the SCE is 1.0% or less. On the other hand, when the refractive index thereof is beyond this range (i.e., 1.45 to 1.65), the SCE may exceed 1.0%.

In addition, a difference in refractive index between the resin portion 161 and the low-refractive-index layer 17 is preferably 0.1 or more. By further increasing the difference in refractive index between the resin portion 161 and the low-refractive-index layer 17, it is possible to further reduce the reflectivity.

The resin portion 161 may be formed from, for example, a (meth)acrylic resin, a polyethylene resin, a polypropylene resin, etc. Alternatively or in addition, for example, a polystyrene resin, a polyurethane resin, a polycarbonate resin, a polyester resin, and/or a silicone resin may be used.

The anisotropic particles 162 have an anisotropic shape and, in the present illustrated embodiment, has an elliptical shape. Due to the shape of the anisotropic particles 162, the refractive index in the longitudinal direction is different from the refractive index in the short direction (i.e., normal to the longitudinal direction). Accordingly, the anisotropic diffusion layer 16 exhibits an anisotropic diffusion property. In addition, the refractive index of the anisotropic particles 162 may be different from the refractive index of the resin portion 161. The shape of the anisotropic particles 162 is not particularly limited, and any anisotropic shape may be employed without departing from the scope of the present disclosure. For example, the shape of the anisotropic particles may be a spindle shape, a needle shape, a fibrous shape, a cylindrical shape, a disk shape, or other anisotropic shapes.

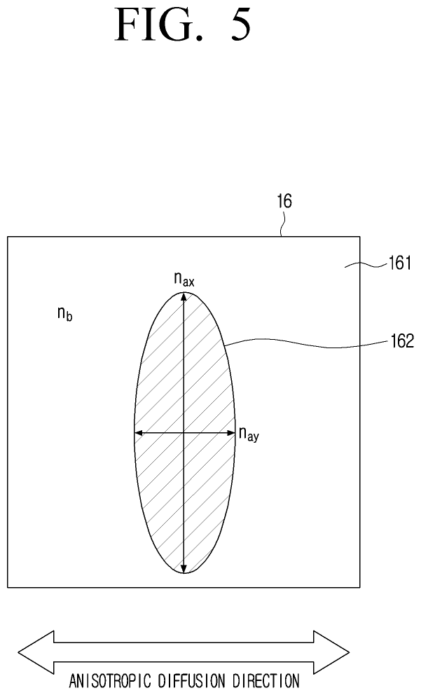

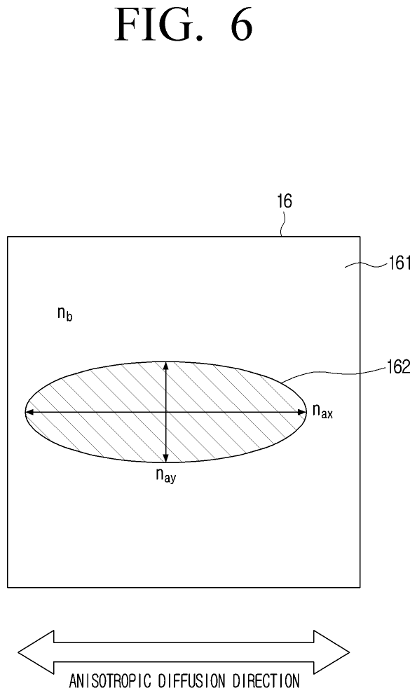

FIGS. 5 and 6 are diagrams illustrating the refractive index of the anisotropic particles 162. Here, the refractive index of the anisotropic particles 162 in the longitudinal direction is defined as nₐₓ, the refractive index thereof in the short direction is defined as n_{ay}, and the refractive index of the resin portion 161 is defined as n_{b}. In this case, when an anisotropic diffusion direction is a transverse direction in the drawing, referring to FIG. 5, a difference between the reference index nₐₓ and the refractive index n_{b} is preferably small. In addition, referring to FIG. 6, a difference between the short direction refractive index n_{ay} and the refractive index n_{b} of the resin portion is preferably small. In other words, a difference between the refractive indexes nₐₓ and n_{ay} of the anisotropic particles 162 in a direction perpendicular to the anisotropic diffusion direction and the refractive index n_{b} of the resin portion 161 is preferably small.

More specifically, it is preferable that at least one of the following relationships (I) and (II) is satisfied. By setting the refractive indexes of the anisotropic particles 162 and the resin portion 161 in the following ranges, back scattering in the direction perpendicular to the anisotropic diffusion direction is suppressed. As such, the SCE of the anisotropic diffusion layer 16 may be decreased.

Relationship (I): |n_{b}−nₐₓ|<0.04 and 0.04<|n_{b}−n_{ay}|<0.50; Relationship (II): |n_{b}−n_{ay}|<0.04 and 0.04<|n_{b}−nₐₓ|<0.50.

In addition, in order to set the SCE of the anisotropic diffusion layer 16 as 1.0% or less, the length or the aspect ratio of the anisotropic diffusion layer 16 is preferably in the following described range(s). If it is beyond this range, the SCE may exceed 1.0%.

For example, the length of the anisotropic particles 162 in the longitudinal direction may be 0.5 μm to 500 μm. In some embodiments, the length of the anisotropic particles 162 in the longitudinal direction may be 1 μm to 200 μm.

Further, for example, the length of the anisotropic particles 162 in the short direction may be 0.05 μm to 30 μm. In some embodiments, the length of the anisotropic particles 162 in the short direction may be 0.1 μm to 10 μm.

By setting the anisotropic particles 162 to have such a size, the back scattering on the interface between the anisotropic particles 162 and the resin portion 161 is suppressed while ensuring excellent anisotropic diffusion property, and the SCE of the anisotropic diffusion layer is reduced.

In some embodiments, an aspect ratio which is a ratio of the length of the anisotropic particles 162 in the longitudinal direction to the length thereof in the short direction is preferably 10 or more. In some embodiments, the aspect ratio may be 20 or more. By setting the aspect ratio of the anisotropic particles 162 in this range, an anisotropic diffusion property capable of improving the viewing angle characteristics of the display may be achieved.

Furthermore, from the same viewpoint, the interface between the anisotropic particles 162 and the resin portion 161 is preferably compatible. Accordingly, the refractive index on the interface between both components continuously changes and the back scattering can be reduced. In addition, the SCE may be further reduced. In this case, a boundary between the anisotropic particles 162 and the resin portion 161 is compatible and thus vague. However, even in this case, it is clear that the anisotropic particles 162 are present as particles in the resin portion 161. As a method for making the interface compatible, a method for blending a compatibilizer is used. In addition, although it will be described later in detail, a method for blending a solution for dissolving a component of the anisotropic particles 162 when applying a coating solution for generating the anisotropic diffusion layer 16 is exemplified. The method for making the interface compatible may be observed by observing a cross section of the anisotropic diffusion layer 16 with a scanning electronic microscope (“SEM”).

The anisotropic particles 162 may contain, for example, at least one of metal oxide, a carbonate compound, a hydroxide compound, and a phosphate compound. The metal oxide may be, for example, silica, titan oxide, aluminum oxide, zinc oxide, or the like. In addition, the anisotropic particles 162 may be formed from, for example, a compound such as calcium carbonate, silicon carbonate, nitrogen carbonate, basic magnesium sulfate, or the like. Further, the anisotropic particles 162 may be formed from a glass fiber, a (meth)acrylic resin, a polystyrene resin, a melamine resin, or the like.

A haze value of the anisotropic diffusion layer 16 is preferably 20% to 80%. In some embodiments, the haze value of the anisotropic layer 16 may be 30% to 65%. Accordingly, it is possible to ensure sharp image quality with less glare when the anisotropic diffusion layer 16 is applied to the display.

The anisotropic diffusion property of the anisotropic diffusion layer 16 may be measured with a goniophotometer. The transmitted light when a light beam is emitted to the anisotropic diffusion layer 16 at an angle of incidence of 0° (i.e., vertical direction) is obtained while changing the acceptance angle. By doing so, an intensity distribution state of the transmitted scattered light is measured. By obtaining this in the anisotropic diffusion direction and the direction perpendicular to the anisotropic diffusion direction, the anisotropic diffusion property can be quantitatively measured. In the present embodiment, the anisotropic diffusion property is evaluated by an anisotropic diffusivity (“ADV”). The anisotropic diffusivity can be calculated by the following mathematical expression. The anisotropic diffusivity ADV of the anisotropic diffusion layer 16 is preferably 3 or more. In some embodiments, the ADV of the anisotropic layer 16 may be 15 or more and in some embodiments may be 25 or more.

ADV=(intensity of transmitted light at 5° in the anisotropic diffusion direction measured with the goniophotometer)/(intensity of transmitted light at 5° in the direction perpendicular to the anisotropic diffusion direction measured with the goniophotometer).

The low-refractive-index layer 17 is a functional layer for reducing the reflectivity of the liquid crystal panel 1a.

The low-refractive-index layer 17 has a small refractive index. Specifically, in some embodiments it may be necessary that the refractive index of the low-refractive-index layer 17 is 1.40 or less. In some embodiments, the refractive index of the low-refractive-index layer 17 may be 1.20 to 1.35. Accordingly, the liquid crystal panel 1a having a low reflectivity may be achieved. The low-refractive-index layer 17 may be formed of a single layer or multi-layers and may be formed of the lowest number of layers as possible, from a viewpoint of production cost. In some embodiments, a thickness of the low-refractive-index layer 17 is preferably 50 nm to 500 nm.

As shown in the embodiment of FIG. 3, the low-refractive-index layer 17 contains a binder 171 with hollow silica particles 172 distributed in the binder 171. In addition, as shown, the low-refractive-index layer 17 further contains a surface modifier 173 mainly distributed on a surface side of the binder 171.

The binder 171 is formed in a net structure and connects the hollow silica particles 172 to each other. The binder 171 contains a resin as a main component. The resin of the binder 171 may contain a fluorine-containing resin. In this case, all of the resin may be the fluorine-containing resin or some thereof may be the fluorine-containing resin. The fluorine-containing resin is a resin containing fluorine, for example, polytetrafluoroethylene (PTFE). In some embodiments, the fluorine-containing resin is, for example, perfluoroalkoxy alkane (PFA). Further, in some embodiments, the fluorine-containing resin is, for example, a perfluoroethylene propene copolymer (FEP) or an ethylene tetrafluoroethylene copolymer (ETFE). The fluorine-containing resin has a low refractive index. Accordingly, by using the fluorine-containing resin, the low-refractive-index layer 17 is likely to have a lower refractive index, thereby further reducing the reflectivity.

In some embodiments it may be advantageous to have the fluorine-resin formed of a photo-curable fluorine-containing resin. The photo-curable fluorine-containing resin may be obtained by photopolymerization of a photopolymerizable fluorine-containing monomer represented by General Formulae (1) and (2), described below. The photo-curable fluorine-containing resin has a structural unit M of 0.1 mol % to 100 mol %. In addition, it has a structural unit A of greater than 0 mol % and equal to or less than 99.9 mol %. Further, it has a number average molecular weight of 30,000 to 1,000,000.

General Formulae:

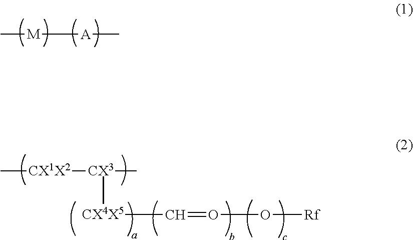

In General Formula (1), the structural unit M is a structural unit derived from a fluorine-containing ethylenic monomer represented by General Formula (2). In addition, the structural unit A is a structural unit derived from a monomer copolymerizable with the fluorine-containing ethylenic monomer represented by General Formula (2).

In General Formula (2), X¹ and X² may be hydrogen (H) or fluorine (F), respectively. Further, for example, in General Formula (2), X³ may be hydrogen (H), fluorine (F), methyl (CH₃), or trifluoromethyl (CF₃). Further, X⁴ and X⁵ may be hydrogen (H), fluorine (F), or trifluoromethyl (CF₃). In General Formula (2), Rf is an organic group in which 1 to 3 Y¹ are bonded to a fluorine-containing alkyl group having 1 to 40 carbon atoms or a fluorine-containing alkyl group having an ether bond having 2 to 100 carbon atoms. Y¹ is a monovalent organic group having 2 to 10 carbon atoms having ethylenic carbon-carbon double bond on a terminal. In addition, in General Formula (2), “a” is 0, 1, 2, or 3 and “b” and “c” are 0 or 1.

As the photopolymerizable fluorine-containing resin, for example, OPTOOL AR-110 manufactured by Daikin Industries, Ltd. may be employed, without departing from the scope of the present disclosure. In addition, EBECRYL 8110 manufactured by DAICEL-ALLNEX LTD., LINC series manufactured by KYOEISHA CHEMICAL Co., LTD., and the like may be employed, without departing from the scope of the present disclosure.

In addition, specific examples of a binder not including fluorine atoms include, without limitation, light acrylate POB-A, NP-A, DCP-A, TMP-A, UA-306I, and UA-306H manufactured by KYOEISHA CHEMICAL Co., LTD., and the like. Examples thereof further include NK ester A-DOD-N, A-200, and A-BPE-4 manufactured by SHIN-NAKAMURA CHEMICAL CO, LTD. Examples thereof further include ARONIX M-315, M-306, and M-408 manufactured by TOAGOSEI CO., LTD. Examples thereof further include KAYARAD DPHA, and DPEA-12 manufactured by Nippon Kayaku Co., Ltd. These binders are effective to improve film hardness.

The hollow silica particles 172 of the low-refractive-index layer 17 includes an outer shell layer and an inner portion of the outer shell layer is hollow or formed of a porous material. The outer shell layer and the porous material are configured with mainly silicon oxide (SiO₂) In addition, a plurality of photopolymerizable groups and hydroxyl groups may be bonded to the surface side of the outer shell layer. The photopolymerizable group and the outer shell layer may be bonded through at least one bond of Si—O—Si bond and a hydrogen bond. Examples of the photopolymerizable group include an acryloyl group and a methacryloyl group. In other words, the hollow silica particles 172 contain at least one of an acryloyl group and a methacryloyl group as the photopolymerizable group. The photopolymerizable group is also referred to as an ionizing radiation curable group. The hollow silica particles 172 may include at least a photopolymerizable group and the number and kind of these functional groups are not particularly limited.

In some embodiments, an average primary particle diameter of the hollow silica particles 172 may be 35 nm to 120 nm. In some embodiments, the average primary particle diameter of the hollow silica particles 172 may be 50 nm to 100 nm. When the average primary particle diameter thereof is less than 35 nm, a porosity of the hollow silica particles 172 decreases. Accordingly, the effect of reducing the refractive index of the low-refractive-index layer 17 is less likely to be exhibited. In addition, when the average primary particle diameter thereof exceeds 120 nm, unevenness of the surface of the low-refractive-index layer 17 may become significant. Accordingly, with such average primary particle diameter, an antifouling property or scratch resistance of the display may be reduced.

The average primary particle diameter of the hollow silica particles 172 may be measured with an observation image of a dry film of a particle dispersion liquid using an scanning electron microscope (“SEM”), a transmission electron microscope (“TEM”), or a scanning transmission electron microscope (“STEM”).

A blending amount of the hollow silica particles 172 in the low-refractive-index layer 17 is preferably between (inclusive) 30% by mass to 65% by mass. When the blending amount of the hollow silica particles 172 is less than 30% by mass, the reflectivity of the low-refractive-index layer 17 is increased relative to blending amounts of 30% or greater. If the blending amount of the hollow silica particles 172 exceeds 65% by mass, the film hardness may be decreased as compared to blending amounts of 65% or less. Further, with relatively high blending amounts, an attached material is more noticeable and is less likely to be easily wiped off of a display surface.

The hollow silica particles 172 may have a plurality of maximum values on a frequency curve (particle size distribution curve) for particle diameters of the hollow silica particles 172. That is, in this case, the hollow silica particles 172 are formed of a plurality of particles having different diameters spanning a particle diameter distribution. For example, the plurality of the average primary particle diameter of the hollow silica particles 172 may be selected from 30 nm, 60 nm, and 75 nm and the particles thereof are mixed and used.

As shown in FIG. 3, the surface modifier 173 is distributed mainly on the surface side of the binder 171 and modifies the surface of the low-refractive-index layer 17. That is, the surface modifier 173 is segregated to the surface side of the low-refractive-index layer 17. Although it may be present inside the binder 171, the function of the low-refractive-index layer 17 is not deteriorated.

In the present embodiment, the surface modifier 173 contains an oil-repellent surface modifier and a lipophilic surface modifier.

The oil-repellent surface modifier is blended with the binder 171 or the like and is segregated to the surface, thereby improving oil repellency of a film surface. The effect of the oil-repellent surface modifier may be checked by measuring a contact angle of oleic acid or the like. In this case, the effect can be checked with a difference in contact angle of the film surface between cases where the oil-repellent surface modifier is added and not added (e.g., contact angle when added—contact angle when not added). In this case, when the oil-repellent surface modifier is added, the contact angle increases. In some embodiments, the difference in contact angle is 10° or more. In other embodiments, the difference in contact angle is 20° or more and still further in some embodiments the contact angle may be 30° or more.

The oil-repellent surface modifier is preferably a fluorine-based compound having a photopolymerizable group.

Specific examples of the oil-repellent surface modifier include KY-1203 and KY-1207 manufactured by Shin-Etsu Chemical Co., Ltd. In addition, examples thereof include OPTOOL DAC-HP manufactured by Daikin Industries, Ltd. Examples thereof further include MEGAFACE F-477, F-554, F-556, F-570, RS-56, RS-58, RS-75, RS-78, and RS-90 manufactured by DIC Corporation. Examples thereof further include FS-7024, FS-7025, FS-7026, FS-7031, and FS-7032 manufactured by Fluoro Technology Co., Ltd. Examples thereof further include H-3593 and H-3594 manufactured by DKS Co. Ltd. Examples thereof further include SURECO AF Series manufactured by AGC Inc. Examples thereof further include FTERGENT F-222F, M-250, 601AD, and 601ADH2 manufactured by NEOS COMPANY LIMITED.

The lipophilic surface modifier is blended with the binder 171 or the like and is segregated to the surface, thereby improving lipophilicity of the film surface. The effect of the lipophilic surface modifier can be checked by measuring the contact angle of oleic acid or the like. In this case, the effect can be checked with a difference in contact angle of the film surface between cases where the lipophilic surface modifier is added and not added (e.g., contact angle when added—contact angle when not added). In this case, when the lipophilic surface modifier is added, the contact angle decreases. In some embodiments, the difference in contact angle is 3° or more. In some embodiments, the difference in contact angle is 5° or more and still further in some embodiments the contact angle may be 7° or more.

As a specific lipophilic surface modifier, for example, Mel-aqua 350L manufactured by SANYO CHEMICAL INDUSTRIES, LTD. In addition, examples thereof include FTERGENT 730LM, 602A, 650A, and 650AC manufactured by NEOS COMPANY LIMITED.

Although an attached material, such as sebum, may be attached to the low-refractive-index layer 17, the attached material is less likely to be noticed. In addition, the attached material may be easily wiped off and removed. The same applies also when a large amount of hollow silica particles 172 are contained.

In addition, the configuration of the resin film of the present embodiment is not limited to the embodiment shown in FIG. 3.

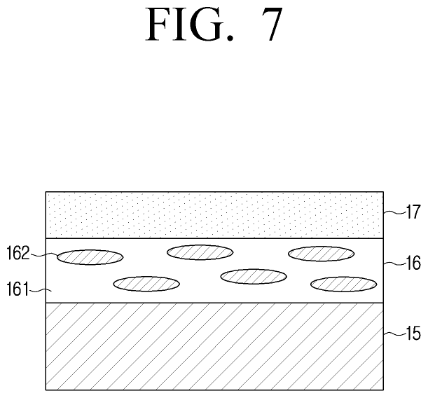

FIGS. 7 to 11 are diagrams illustrating examples of various configurations of the resin films in accordance with example embodiments of the present disclosure.

Among these, FIG. 7 is arranged in the same manner as that illustrated in FIG. 3, with the base material 15, the anisotropic diffusion layer 16, and the low-refractive-index layer 17 arranged and laminated in this order.

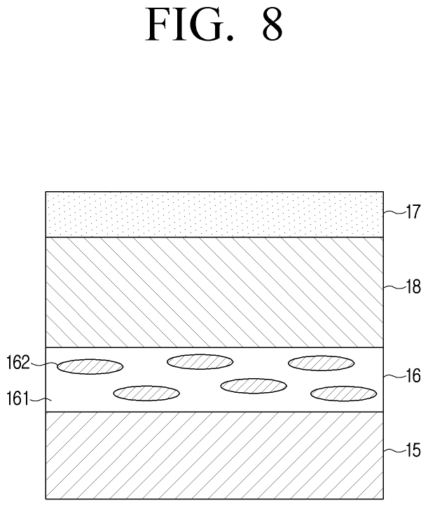

FIG. 8 is a diagram illustrating an example in which the base material 15, the anisotropic diffusion layer 16, a hard coating layer 18, and the low-refractive-index layer 17 are arranged and laminated in this order. In other words, compared to the case of FIG. 7, the hard coating layer 18 is formed between the anisotropic diffusion layer 16 and the low-refractive-index layer 17. In this case, the hardness of the resin film may be improved. The refractive index of the hard coating layer 18 may be selected to be 1.54 or less. Accordingly, the reflectivity may be reduced compared to the case of including only the low-refractive-index layer 17. In addition, more excellent antireflection property may be given.

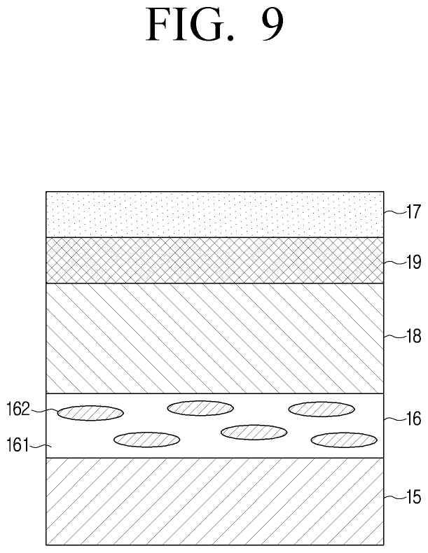

FIG. 9 is a diagram illustrating an example in which the base material 15, the anisotropic diffusion layer 16, the hard coating layer 18, a high-refractive-index layer 19, and the low-refractive-index layer 17 are arranged and laminated in this order. In other words, compared to the case of FIG. 8, the high-refractive-index layer 19 is formed between the hard coating layer 18 and the low-refractive-index layer 17. The high-refractive-index layer 19 is a layer having a higher refractive index than that of the low-refractive-index layer 17. The refractive index of the high-refractive-index layer 19 may be selected to be 1.60 or greater. Accordingly, the reflectivity may be reduced compared to the case of including only the low-refractive-index layer 17. In addition, improved antireflection properties may be provided.

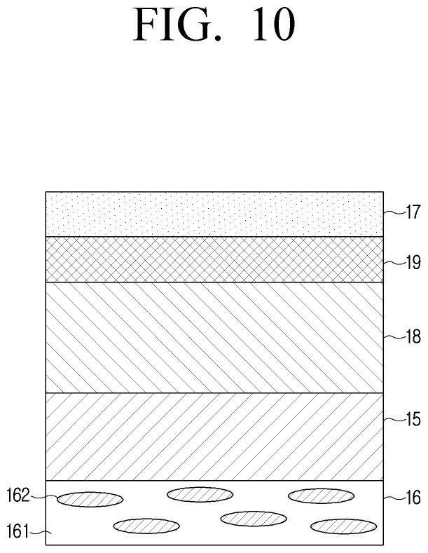

FIG. 10 is a diagram illustrating an example in which the anisotropic diffusion layer 16, the base material 15, the hard coating layer 18, the high-refractive-index layer 19, and the low-refractive-index layer 17 are arranged and laminated in this order. In other words, compared to the case of FIG. 7, the anisotropic diffusion layer 16 is moved to the inner side with respect to the base material 15. In this case, it may be said that the base material 15 is provided between the low-refractive-index layer 17 and the anisotropic diffusion layer 16.

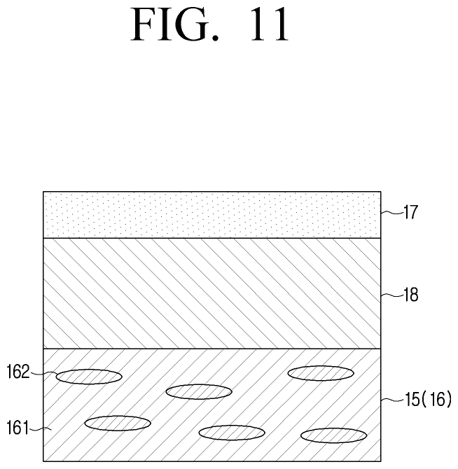

FIG. 11 illustrates a case where the base material 15 has the function of the anisotropic diffusion layer 16. That is, FIG. 11 illustrates a case where the anisotropic particles 162 are dispersed in the resin constituting the base material 15. In this case, it may be said that the anisotropic diffusion layer 16 functions as the base material 15 for supporting the low-refractive-index layer 17.

The hard coating layer 18 is a functional layer for preventing generation of scratches on the liquid crystal panel 1a. The hard coating layer 18 is formed of, for example, a binder as a base material containing a resin as a main component. As the binder, the same elements exemplified as for the low-refractive-index layer 17 may be used.

In addition, in addition to the binder, metal oxide particles may also be included. The metal oxide particles may include, for example and without limitation, zirconium oxide, tin oxide, titanium oxide, and cerium oxide. Accordingly, a hard coating property of the hard coating layer 18 may be improved.

In addition, a conductive substance may be added. The conductive substance may be, for example, metal fine particles or a conductive polymer. More specifically, the conductive substance may be, for example, tin oxide doped with antimony (Sb), phosphorus (P), or indium (In), an ion liquid containing fluorine-based anion or ammonium salt, a conductive polymer such as PEDOT/PSS, carbon nanotube(s), or the like. In addition, the conductive substance may not be limited to one kind and two or more kinds thereof may be added. Accordingly, a surface resistance value of the hard coating layer 18 may be decreased and an antistatic function may be given to the hard coating layer 18.

In accordance with some embodiments, in order to reduce the reflection of the liquid crystal panel 1a, a refractive index of the hard coating layer 18 may be 1.48 to 1.65. In some embodiments, the refractive index of the hard coating layer 18 may be 1.50 to 1.60 and in some embodiments may be 1.54 to 1.56. It is possible to reduce the reflectivity by increasing the refractive index of the hard coating layer 18. In contrast, if the refractive index of the hard coating layer 18 increases greatly, the angle dependency of the reflectivity may be deteriorated and it may be difficult to adjust color.

In some embodiments, a thickness of the hard coating layer 18 may be 0.5 μm to 20 μm. In some embodiments, the thickness of the hard coating layer 18 may be 3 μm to 10 μm.

In some embodiments, the high-refractive-index layer 19 (FIGS. 9-10) may optionally be provided on a lower layer of the low-refractive-index layer 17 and is a functional layer for further reducing the reflectivity.

The high-refractive-index layer 19 may contain a binder and high-refractive-index particles. The high-refractive-index layer 19 may be formed of, for example, a coating solution containing a binder and high-refractive-index particles. The high-refractive-index layer 19 may be formed of a single layer or multi-layers and, in some embodiments, may be formed of the smallest number of layers as possible, from a viewpoint of production cost.

In order to reduce the reflectivity of the liquid crystal panel 1a, the refractive index of the optional high-refractive-index layer 19 is preferably high. Specifically, the refractive index thereof may be 1.55 to 1.80 or, in some embodiments may be 1.60 to 1.75.

In some embodiments, an upper limit of the thickness of the high-refractive-index layer 19 may be 500 nm or less. In some embodiments, the upper limit thereof may be 350 nm or even 200 nm. A lower limit of the thickness of the high-refractive-index layer 19 may be 50 or more. In some embodiments, the lower limit thereof may be 80 nm or greater and, in some embodiments, may be 100 nm or greater.

Examples of the high-refractive-index particles include, without limitation, zirconium oxide, hafnium oxide, tantalum oxide, titanium oxide, zinc oxide, aluminum oxide, magnesium oxide, tin oxide, yttrium oxide, barium titanate, antimony-doped tin oxide (ATO), phosphorus-doped tin oxide (PTO), indium-doped tin oxide (ITO), and zinc sulfide. From a viewpoint of durability stability, zirconium oxide, barium titanate, antimony-doped tin oxide (ATO), phosphorus-doped tin oxide (PTO), and indium-doped tin oxide (ITO) may be preferable.

An average particle diameter of the primary particles (e.g., average primary particle diameter) of the high-refractive-index particles may be 1 nm to 200 nm. In some embodiments, the average particle diameter of the primary particles of the high-refractive-index particles may be 3 nm to 100 nm and, in some embodiments, may be 5 nm to 50 nm.

The average primary particle diameter of the high-refractive-index particles may be measured with an observation image of the dry film of the particle dispersion liquid obtained using a SEM, a TEM, or a STEM, similar to that described above.

A dispersion stabilization process is preferably performed for the high-refractive-index particles, from a viewpoint of suppressing the aggregation. As the means for the dispersion stabilization, means for using surface-processed particles or adding an additive may be used. In addition, means for adding other particles having a smaller surface load amount than that of the high-refractive-index particles may also be used.

A content of the high-refractive-index particles is preferably 20 parts by mass to 500 parts by mass with respect to 100 parts by mass of the binder. In some embodiments, the content thereof may be 50 parts by mass to 400 parts by mass and, in some embodiments, 100 parts by mass to 300 parts by mass.

As the binder, the same binder as exemplified for the low-refractive-index layer 17 may be used. However, in order to reduce the content of the high-refractive-index particles, a refractive index of the binder may be approximately 1.50 to 1.70.

The high-refractive-index layer 19 may contain other components, if necessary, in addition to the binder and the high-refractive-index particles. For example, the high-refractive-index layer 19 may contain an additive such as a polymerization initiator, an ultraviolet absorber, a labelling agent, a surfactant, and/or a diluent solvent. The addition of the labelling agent or the surfactant may control a surface state of the high-refractive-index layer 19, and as a result, it is possible to improve performance of the upper layer. In this case, the upper layer is, for example, the low-refractive-index layer 17.

In addition, a film including the resin film of the present embodiment may be used as a surface film of a polarizing plate.

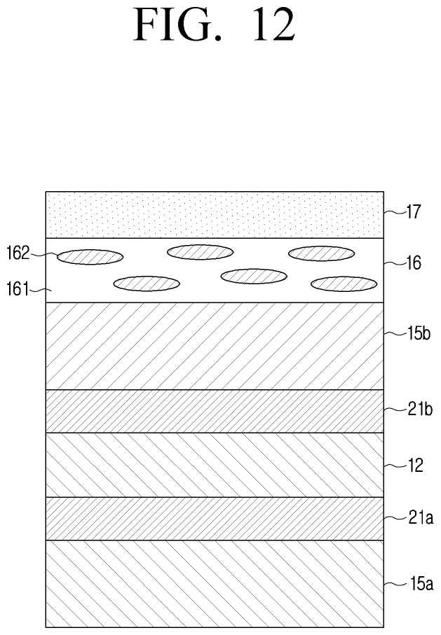

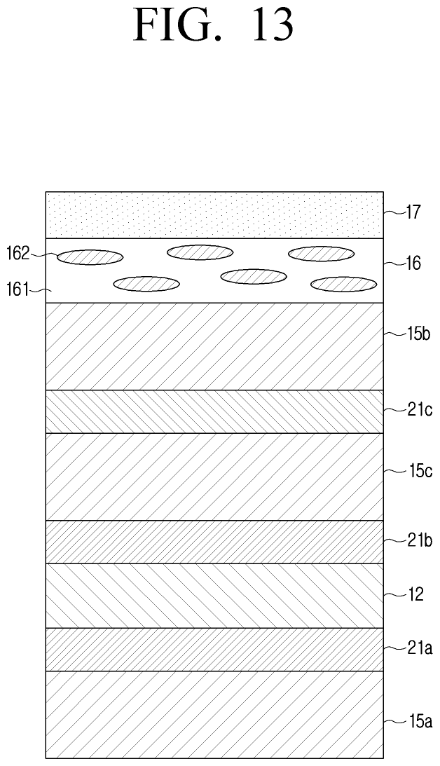

FIGS. 12 and 13 are diagrams illustrating examples of a configuration of a polarizing plate to which the present embodiment is applied.

In the polarizing plate illustrated in FIG. 12, a base material 15a, an adhesive layer 21a, and a polarizing film 12 are laminated. An adhesive layer 21b, a base material 15b, an anisotropic diffusion layer 16, and a low-refractive-index layer 17 are laminated thereon. In this illustrative embodiment, each of the base material (15a, 15b) and the adhesive layer (21a, 21b) is formed of two layers. However, those of skill in the art will appreciated that the base material and the adhesive layer(s) may be configured with the same material. In addition, the base material and the adhesive layer may be configured with different materials.

As shown in FIG. 12, the polarizing film 12 is bonded onto the base material 15a with the adhesive layer 21a. The resin film formed of the base material 15b, the anisotropic diffusion layer 16, and the low-refractive-index layer 17 are bonded thereto with the adhesive layer 21b. The adhesive layers 21a, 21b are, for example, layers formed of an ultraviolet (UV) adhesive. In some embodiments, the adhesive layers 21a, 21b may be a pressure-sensitive adhesive (PSA). In some embodiments, the adhesive layers 21a, 21b may be an optical-clear adhesive (OCA). In some embodiments, the adhesive layers 21a, 21b may be an optical-clear resin (OCR). Among these, the UV adhesive may be suitably used.

In the polarizing plate illustrated in FIG. 13, the base material 15a, the adhesive layer 21a, and the polarizing film 12 are laminated. The adhesive layer 21b and a base material 15c are laminated thereon. In addition, an adhesive layer 21c, the base material 15b, the anisotropic diffusion layer 16, and the low-refractive-index layer 17 are laminated thereon. In other words, the polarizing plate illustrated in FIG. 13 is different from the polarizing plate of FIG. 12 in that the additional base material 15c and the additional adhesive layer 21c are added. In this case, for example, the adhesive layers 21a, 21b may be set as layers formed of a UV adhesive and the adhesive layer 21c may be formed of a PSA material.

<Description of Method for Producing Resin Film>

Next, a method for producing the resin film having a layer structure as illustrated in FIG. 3 will be described.

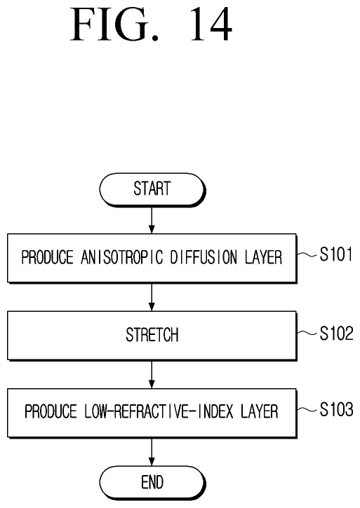

FIG. 14 is a flowchart illustrating a method for producing a resin film having a layer structure illustrated in FIG. 3.

First, the anisotropic diffusion layer 16 is produced (Step S101: Anisotropic diffusion layer producing step). The anisotropic diffusion layer 16 may be applied on the base material 15 or the anisotropic diffusion film may be formed by melt extrusion and the like.

If necessary, the anisotropic diffusion layer 16 is stretched (Step S102: stretching step). By stretching the anisotropic diffusion layer 16, an alignment property of the anisotropic particles 162 may be improved and the anisotropic diffusion property thereof may be improved. In addition, by stretching the anisotropic diffusion layer 16 containing organic particles such as a (meth)acrylic resin, a polystyrene resin, and a melamine resin to approximate a glass transition point of the resin, the organic particles having the anisotropic shape and the anisotropic diffusion property may be significantly improved. That is, an isotropic diffusion film containing isotropic particles may be provided before the stretching. By stretching this, the isotropic particles change to the anisotropic particles 162. As a result, an anisotropic diffusion film containing the anisotropic particles 162 is obtained.

In addition, the low-refractive-index layer 17 is produced on the anisotropic diffusion layer 16 (Step S103: low-refractive-index layer producing step).

In addition, each layer of the anisotropic diffusion layer 16 and the low-refractive-index layer 17 may be produced by the following method.

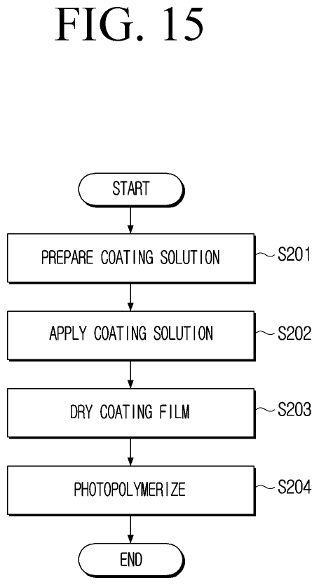

FIG. 15 is a flowchart illustrating a method for producing the anisotropic diffusion layer 16 and the low-refractive-index layer 17.

First, a coating solution for forming each layer is prepared (Step S201: preparing step). Here, the “preparation” contains a case of preparing by purchasing a coating solution, in addition to a case of preparing by producing a coating solution.

The coating solution is formed of a solid content and a solvent.

In a case of producing the anisotropic diffusion layer 16, the solid content contains a monomer, an oligomer, and a polymer which is a base of the resin portion 161. In addition, the solid content contains the anisotropic particles 162. The monomer and/or the oligomer becomes a resin to be contained in the resin portion 161 by polymerization. In the present embodiment, the polymerization is photopolymerization or thermal polymerization. Herein, the monomer and/or the oligomer may be referred to as a “binder component”.

In a case of producing the low-refractive-index layer 17, the solid content contains the binder component which is the base of the binder 171. In addition, the solid content contains the hollow silica particles 172 and the surface modifier 173.

In addition, a photopolymerization initiator is contained as the solid content of each layer. Further, a dispersing agent, a defoaming agent, an ultraviolet absorber, a labelling agent, and the like may be contained in the solid content.

Each solid content is put into a solvent and stirred, thereby producing a coating solution for each layer.

The solvent disperses the solid content. The solvent may be, for example, methylene chloride, toluene, xylene, ethyl acetate, butyl acetate, and/or acetone. In addition, methyl ethyl ketone (MEK), methyl isobutyl ketone (MIBK), ethanol, methanol, and normal propyl alcohol may be used. Further, isopropyl alcohol, tert-butyl alcohol, 1-butanol, mineral spirit, oleic acid, and cyclohexanone may be used. Further, N-methyl-2-pyrrolidone (NMP), dimethyl phthalate (DMP), dimethyl carbonate, and dioxolane can be used.

A concentration of the solid content in the coating solution may be, for example, 2 wt % to 80 wt %. The anisotropic diffusion layer 16 is coated in a high viscous state by increasing the concentration of the solid content. Accordingly, a strong shear force is applied during the coating and the alignment property of the anisotropic particles 162 may be improved. In addition, in a case of forming an ultra-thin film of nm-order, such as the low-refractive-index layer 17, it may be desirable to ensure film thickness uniformity during the coating by reducing the concentration of the solid content.

Returning to FIG. 15, the coating solution is applied (coated) and a coating film is produced (Step S202: coating step). A method for performing the coating is not particularly limited, and a method for coating by a die method or a micro gravure method may be used. In addition, a method for dropping and rotating the coating solution, and producing a film-like body having a uniform thickness with centrifugal force may be used. The coating solution may be applied in a heated state. As such, embodiments of the present disclosure are not limited to a single process.

In this case, the surface modifier of the low-refractive-index layer 17 is segregated to the surface side of the coating film.

In addition, the coated coating film is dried (Step S203: drying step). The drying may be performed by a method for volatizing the solvent by leaving it at room temperature or a method for forcibly removing the solvent by heating or vacuum drawing.

Energy, such as ultraviolet light or heat, is directed or applied to polymerize the binder component in the coating film. Accordingly, the binder component is cured in the coating film to obtain the resin portion 161 and the binder 171 (Step S204: polymerization step). Through the above steps, each layer of the anisotropic diffusion layer 16 and the low-refractive-index layer 17 may be formed. The drying step and the polymerization step may be considered as a curing step for curing the coated coating solution.

According to the resin film described above, the anisotropic diffusion layer 16 is provided. Accordingly, the incident light is scattered in a specific direction. An increase in viewing angle of the display is achieved while maintaining excellent antireflection characteristics or surface luminance, and contrast.

In addition, according to the resin film described above, the refractive indexes of the anisotropic particles 162 and the resin portion 161 are optimized as the expressions (I) and (II). Accordingly, it is possible to suppress the back scattering in the anisotropic diffusion layer 16 and reduce the SCE. Even in a case where the low-refractive-index layer 17 is provided, excellent antireflection characteristics are achieved.

In addition, in a case of providing the hard coating layer 18 and the high-refractive-index layer 19, it is possible to optimally reduce the reflectivity by setting the refractive index as described above. That is, it is possible to reduce the reflectivity more than the case where only the low-refractive-index layer 17 is provided. Thus, improved antireflection characteristics may be achieved.

In addition, as illustrated in FIGS. 12-13, the resin film and the polarizing film 12 may be bonded using adhesive layers 21a, 21b, 21c. Accordingly, it is possible to significantly reduce the number of laminated layers, compared to an anisotropic diffusion film of an uneven structure type. This contributes to the improvement of luminance of the display and cost reduction. Because the uneven structure is not used, iridescent unevenness derived from diffraction of the structure does not occur, even in a case where external light such as illumination is incident, thereby exhibiting excellent antireflection effect.

The example has described a case where the anisotropic diffusion layer 16 and the low-refractive-index layer 17 are formed in the liquid crystal panel of the display apparatus 1. However, there is no limitation thereto, and for example, an organic EL (e.g., OLED) or a cathode-ray tube.

In addition, these layers may be formed on a surface of a lens, or the like, formed of a material such as glass or plastic. In this case, the lens or the like is an example of the base. In addition, the lenses or the like used to form the anisotropic diffusion layer 16 and the low-refractive-index layer 17 is an example of an optical member. In addition, as the base material, a film formed of TAC or the like may be used. These layers may be formed on this film. This may be used as a low-refractive-index film or an antireflection film. This is also an example of the optical member.

In the above example, it was described that the binder component is polymerized by photopolymerization. In other embodiments, the binder component may be polymerized by thermal polymerization, for example.

In addition, as illustrated in FIG. 11, the anisotropic diffusion layer 16 may be used as the base material 15.

### EXAMPLES

Hereinafter, the present disclosure will be described in detail with reference to various non-limiting examples. The present disclosure is not limited to these examples as long as it does not depart from the gist thereof.

[Formation of Anisotropic Diffusion Layer 16]

First, the method for producing the anisotropic diffusion layer 16 will be described. Herein, anisotropic diffusion layers, referred to as AD-1 to AD-10, were produced as the anisotropic diffusion layer 16 by the method described herein. In addition, isotropic diffusion layers, referred to as ID-1 to ID-2, were produced. The isotropic diffusion layers ID-1 to ID-2 are diffusion layers having isotropic light diffusion property. The anisotropic diffusion layers AD-1 to AD-10 contain the anisotropic particles 162. Meanwhile, the isotropic diffusion layers ID-1 to ID-2 contain isotropic particles.

(Anisotropic Diffusion Layer AD-1)

The anisotropic diffusion layer AD-1 was produced as below.

An acrylic oligomer having an acryloyl group having a refractive index of 1.51 was dissolved in a mixed solution of methyl ethyl ketone and methyl isobutyl ketone. In this embodiment, 65 parts by mass of needle-shaped calcium carbonate particles as the anisotropic particles 162 with respect to 100 parts by mass of the acrylic oligomer was blended with the mixed liquid. The needle-shaped calcium carbonate particles have an average of lengths in the longitudinal direction of 20 μm and an average of lengths in the short direction of 0.6 μm. In addition, the refractive index is 1.66 in the longitudinal direction and 1.50 in the short direction. Further, 4 parts by mass of a photopolymerization initiator (e.g., IRGACURE 127 manufactured by IGM Resin) was blended. After that, methyl ethyl ketone and dimethyl carbonate were added and the concentration of the solid content was adjusted to 80% by mass.

This composition was applied to the TAC film, which is equivalent to the base material 15, using a bar coater. This TAC film has a film thickness of 60 μm. Next, after drying the TAC film at 80° C. for 2 minutes, a high pressure mercury lamp having an illuminance of 200 mW/cm² was emitted and applied for 3 minutes to cure the layers. Accordingly, the anisotropic diffusion layer AD-1 was obtained on the film-shaped base material 15. A film thickness of the anisotropic diffusion layer AD-1 was 10 μm.

(Anisotropic Diffusion Layer AD-2)

The anisotropic diffusion layer AD-2 was produced by the same method as for the anisotropic diffusion layer AD-1, except that the anisotropic particles 162 are changed. The anisotropic particles 162, in this embodiment, are needle-shaped calcium carbonate particles, and an average of lengths in the longitudinal direction is 160 μm and an average of lengths in the short direction is 8 μm. That is, the particles are larger in this embodiment (AD-2) than those of the anisotropic diffusion layer AD-1. In addition, the refractive index is 1.66 in the longitudinal direction and 1.50 in the short direction. A film thickness of the anisotropic diffusion layer AD-2 was 10 μm.

(Anisotropic Diffusion Layer AD-3)

The anisotropic diffusion layer AD-3 was produced by the same method as for the anisotropic diffusion layer AD-1 except that the anisotropic particles 162 are changed. The anisotropic particles 162, in this embodiment, are needle-shaped calcium carbonate particles, and an average of lengths in the longitudinal direction is 3 μm and an average of lengths in the short direction is 0.2 μm. That is, the particles are smaller in this embodiment (AD-3) than those of the anisotropic diffusion layer AD-1. In addition, the refractive index is 1.66 in the longitudinal direction and 1.50 in the short direction. A film thickness of the anisotropic diffusion layer AD-3 was 10 μm.

(Anisotropic Diffusion Layer AD-4)

The anisotropic diffusion layer AD-4 was produced as below. The anisotropic diffusion layer AD-4 was produced as below by changing the anisotropic particles 162, compared to the anisotropic diffusion layer AD-1.

The acrylic oligomer having an acryloyl group having a refractive index of 1.49 was dissolved in a mixed solution of methyl ethyl ketone and methyl isobutyl ketone. In this embodiment, 80 parts by mass of a basic magnesium sulfate fiber as the anisotropic particles 162 with respect to 100 parts by mass of the acrylic oligomer was blended with the mixed solution. The basic magnesium sulfate fiber has an average of lengths in the longitudinal direction of 30 μm and an average of lengths in the short direction of 0.8 μm. In addition, the refractive index is 1.55 in the longitudinal direction and 1.50 in the short direction. Further, 4 parts by mass of the photopolymerization initiator (e.g., IRGACURE 127 manufactured by IGM Resin) was blended. After that, methyl ethyl ketone and dimethyl carbonate were added and the concentration of the solid content was adjusted to 70% by mass.

This composition was applied to a TAC film, which is the base material 15, using a bar coater. The TAC film, of this embodiment, has a film thickness of 60 μm. Next, after drying the TAC film at 80° C. for 2 minutes, a high pressure mercury lamp having an illuminance of 200 mW/cm² was emitted for 3 minutes for curing. Accordingly, the anisotropic diffusion layer AD-4 was obtained on the film-shaped base material 15. A film thickness of the anisotropic diffusion layer AD-4 was 10 μm.

(Anisotropic Diffusion Layer AD-5)

The anisotropic diffusion layer AD-5 was produced as below by changing the anisotropic particles 162, compared to the anisotropic diffusion layer AD-1.

The acrylic oligomer having an acryloyl group having a refractive index of 1.49 was dissolved in a mixed solution of methyl ethyl ketone and methyl isobutyl ketone. In this embodiment, 30 parts by mass of needle-shaped titanium oxide particles as the anisotropic particles 162 with respect to 100 parts by mass of the acrylic oligomer was blended with the mixed solution. The needle-shaped titanium oxide particles have an average of lengths in the longitudinal direction of 20 μm and an average of lengths in the short direction of 0.2 μm. In addition, the refractive index is 2.27 in the longitudinal direction and 2.10 in the short direction. Further, 4 parts by mass of the photopolymerization initiator (e.g., IRGACURE 127 manufactured by IGM Resin) was blended. After that, methyl ethyl ketone and dimethyl carbonate were added and the concentration of the solid content was adjusted to 75% by mass.

This composition was applied to a TAC film, which is the base material 15, using a bar coater. The TAC film of this embodiment has a film thickness of 60 μm. Next, after drying the TAC film at 80° C. for 2 minutes, a high pressure mercury lamp having an illuminance of 200 mW/cm² was emitted for 3 minutes for curing. Accordingly, the anisotropic diffusion layer AD-5 was obtained on the film-shaped base material 15. A film thickness of the anisotropic diffusion layer AD-5 was 10 μm.

(Anisotropic Diffusion Layer AD-6)

The anisotropic diffusion layer AD-6 was produced as below by changing the anisotropic particles 162, compared to the anisotropic diffusion layer AD-1.

In this embodiment, an acrylic oligomer having an acryloyl group having a refractive index of 1.49 was dissolved in a mixed solution of methyl ethyl ketone and methyl isobutyl ketone. In this embodiment, 40 parts by mass of a glass long fiber as the anisotropic particles 162 with respect to 100 parts by mass of the acrylic oligomer was blended with the mixed solution. The glass long fiber has an average of lengths in the longitudinal direction of 120 μm and an average of lengths in the short direction of 4 μm. In addition, the refractive index is 1.55. Further, 4 parts by mass of the photopolymerization initiator (e.g., IRGACURE 127 manufactured by IGM Resin) was blended. After that, methyl ethyl ketone and dimethyl carbonate were added and the concentration of the solid content was adjusted to 65% by mass.

This composition was applied to a TAC film, which is the base material 15, using a bar coater. The TAC film has a film thickness of 60 μm. Next, after drying the TAC film at 80° C. for 2 minutes, a high pressure mercury lamp having an illuminance of 200 mW/cm² was emitted for 3 minutes for curing. Accordingly, the anisotropic diffusion layer AD-6 was obtained on the film-shaped base material 15. A film thickness of the anisotropic diffusion layer AD-6 was 10 μm.

(Anisotropic Diffusion Layer AD-7)

The anisotropic diffusion layer AD-7 was produced by the same method as for the anisotropic diffusion layer AD-1, except that the anisotropic particles 162 are changed. The anisotropic particles 162 are needle-shaped calcium carbonate particles, and an average of lengths in the longitudinal direction is 0.8 μm and an average of lengths in the short direction is 0.1 μm. That is, the particles are smaller in this embodiment (AD-7) than those of the anisotropic diffusion layer AD-3. In addition, the refractive index is 1.66 in the longitudinal direction and 1.50 in the short direction. A film thickness of the anisotropic diffusion layer AD-7 was 10 μm.

(Anisotropic Diffusion Layer AD-8)

The anisotropic diffusion layer AD-8 was produced by the same method as for the anisotropic diffusion layer AD-1, except that the anisotropic particles 162 are changed. The anisotropic particles 162 are needle-shaped calcium carbonate particles, and an average of lengths in the longitudinal direction is 250 μm and an average of lengths in the short direction is 12 μm. That is, the particles are larger in this embodiment (AD-8) than those of the anisotropic diffusion layer AD-2. In addition, the refractive index is 1.66 in the longitudinal direction and 1.50 in the short direction. A film thickness of the anisotropic diffusion layer AD-8 was 10 μm.

(Anisotropic Diffusion Layer AD-9)

A polymethyl methacrylate resin having a refractive index of 1.50 was dissolved in a mixed solution of methyl ethyl ketone and methyl isobutyl ketone. In this embodiment, 70 parts by mass of polystyrene particles as the anisotropic particles 162 with respect to 100 parts by mass of the polymethyl methacrylate resin was blended with the mixed solution. The polystyrene particles has an average particle diameter of 5 μm, and a refractive index of 1.60. After that the mixing and blending, methyl ethyl ketone was added and the concentration of the solid content was adjusted to 70% by mass.

This composition was applied to a release-treated PET film using a bar coater. Next, after drying the film at 80° C. for 5 minutes, a resin film having a film thickness of 600 μm was obtained by peeling the PET film off. This resin film was stretched 3.5 times in an atmosphere in the vicinity of the glass transition point of polystyrene (90° C. to 120° C.), and the anisotropic diffusion layer AD-9 was obtained. A film thickness of the anisotropic diffusion layer AD-9 was 60 μm.

(Anisotropic Diffusion Layer AD-10)

The anisotropic diffusion layer AD-10 was produced by the same method as for the anisotropic diffusion layer AD-1 except that the anisotropic particles 162 are changed. The anisotropic particles 162 of this embodiment are needle-shaped calcium carbonate particles, and an average of lengths in the longitudinal direction is 220 μm and an average of lengths in the short direction is 12 μm. That is, the particles are larger in this embodiment (AD-10) than those of the anisotropic diffusion layer AD-8. In addition, the refractive index is 1.66 in the longitudinal direction and 1.50 in the short direction. A film thickness of the anisotropic diffusion layer AD-10 was 10 μm.

(Isotropic Diffusion Layer ID-1)

The isotropic diffusion layer ID-1 was produced as below.

An acrylic oligomer having an acryloyl group having a refractive index of 1.51 was dissolved in a mixed solution of methyl ethyl ketone and methyl isobutyl ketone. In this embodiment, 65 parts by mass of calcium carbonate particles as the anisotropic particles 162 with respect to 100 parts by mass of the acrylic oligomer was blended with the mixed solution. The calcium carbonate particles has an average particle diameter of 3 μm. In addition, a refractive index thereof is 1.65. Further, 4 parts by mass of the photopolymerization initiator (e.g., IRGACURE 127 manufactured by IGM Resin) was blended. After that, methyl ethyl ketone and dimethyl carbonate were added and the concentration of the solid content was adjusted to 65% by mass.

This composition was applied to a TAC film, which is the base material 15, using a bar coater. This TAC film has a film thickness of 60 μm. Next, after drying the TAC film at 80° C. for 2 minutes, a high pressure mercury lamp having an illuminance of 200 mW/cm² was emitted for 3 minutes for curing. Accordingly, the isotropic diffusion layer ID-1 was obtained on the film-shaped base material 15. A film thickness of the isotropic diffusion layer ID-1 was 10 μm.

(Isotropic Diffusion Layer ID-2)

The isotropic diffusion layer ID-2 was produced as below.

A polymethyl methacrylate resin having a refractive index of 1.50 was dissolved in a mixed solution of methyl ethyl ketone and methyl isobutyl ketone. In this embodiment, 70 parts by mass of polystyrene particles with respect to 100 parts by mass of the polystyrene resin was blended with the mixed solution. The polystyrene particles has an average particle diameter of 5 μm. In addition, a refractive index thereof is 1.60. After that, methyl ethyl ketone was added and the concentration of the solid content was adjusted to 70% by mass.

This composition was applied to a release-treated PET film using a bar coater. Then, it is dried at 80° C. for 5 minutes. After drying, a resin film having a film thickness of 60 μm was obtained by peeling the PET film off.

[Formation of Hard Coating Layer 18]

Herein, example coating solutions, referred to as HC-1 to HC-3, of the hard coating layer 18 were produced with the composition shown in Table 1.

(Coating Solution HC-1)

The coating solution HC-1 contains a monomer and/or oligomer which is the binder component. In addition, the coating solution HC-1 contains a photopolymerization initiator, a defoaming agent, and a solvent. For the binder component of this embodiment, UA-306T manufactured by KYOEISHA CHEMICAL Co., LTD. was used. In addition, the binder component of this embodiment included Viscoat #300 manufactured by OSAKA ORGANIC CHEMICAL INDUSTRY LTD., and KAYARAD PET-30 manufactured by Nippon Kayaku Co., Ltd. were used.

Further, the photopolymerization initiator of this embodiment included IRGACURE184 manufactured by BASF Japan Ltd. Further, the defoaming agent of this embodiment included NR-121X-9IPA manufactured by COLCOAT CO., LTD. Further, the defoaming agent BYK-066N manufactured by ALTANA was used. These are solid contents with a blending ratio is as shown in Table 1.

The solid contents were put into a solvent and stirred to be 50% by mass. Propylene glycol monomethyl ether and ethyl acetate were used as the solvent in this embodiment.

(Coating Solution HC-2)

In the coating solution HC-2, metal oxide particles were added, compared to the coating solution HC-1. Zirconium oxide, which is nanoparticles having an average primary particle diameter of 30 nm, was used as the metal oxide particles. In addition, NR-121X-9IPA, manufactured by COLCOAT CO., LTD., which is an antistatic agent, was not used. A blending ratio thereof is as shown in Table 1.

(Coating Solution HC-3)

In the coating solution HC-3, the solvent was changed compared to the coating solution HC-1. That is, dimethyl carbonate was used as the solvent in addition to propylene glycol monomethyl ether and ethyl acetate. A blending ratio thereof is as shown in Table 1. Accordingly, the coating solution HC-3 was produced.

The coating solutions HC-1 to HC-3 were applied with a wire bar and a coating film was produced. In addition, the coating film was left at room temperature for 1 minute and heated at 80° C. for 1 minute to be dried. An ultraviolet lamp (e.g., metal halide lamp, illuminance of 300 mW/cm²) was emitted for 1 second. Accordingly, the coating film may be cured. Through the above steps, the hard coating layer 18 may be formed.

TABLE 1

| Type | Material name | HC-1 | HC-2 | HC-3 |
|---|---|---|---|---|
| Binder component | UA-306T | 72 | 65 | 72 |
| | Viscoat #300 | 10 | 10 | 10 |
| | KAYARAD PET-30 | 10 | 5 | 10 |
| Metal oxide particles | Zirconium oxide | — | 15 | — |
| | (average primary | | | |
| | particle | | | |
| | diameter of 30 nm) | | | |
| Photopolymerization | IRGACURE 184 | 4.95 | 4.95 | 4.95 |
| initiator | | | | |
| Defoaming agent | NR-121X-9IPA | 3 | — | 3 |
| | BYK-066N | 0.05 | 0.05 | 0.05 |
| | Total | 100 | 100 | 100 |
| Solvent | Propylene glycol | 60 | 60 | 30 |
| | monomethyl ether | | | |
| | Ethyl acetate | 40 | 40 | 50 |
| | Dimethyl carbonate | — | — | 20 |

| | | | |
|---|---|---|---|
| Refractive index | 1.52 | 1.56 | 1.52 |

* The unit is parts by mass.

[Formation of High-Refractive-Index Layer 19]

Next, a method for producing the high-refractive-index layer 19 will be described. Herein, a coating solution HR-1 of the high-refractive-index layer 19 was produced with the composition shown in Table 2.

(Coating Solution HR-1)

The coating solution HR-1 contains a monomer and/or oligomer, which is the binder component, high-refractive-index particles, and a photopolymerization initiator. In addition, the coating solution HR-1 contains a surface modifier and a solvent. As the binder component of this embodiment, KAYARAD DPHA manufactured by Nippon Kayaku Co., Ltd. was used. In addition, zirconium oxide, which are nanoparticles having an average primary particle diameter of 10 nm, were used as the high-refractive-index particles. Further, IRGACURE184 manufactured by BASF Japan Ltd. was used as the photopolymerization initiator. In this embodiment, MEGAFACE F-568 manufactured by DIC Corporation was used as the surface modifier. These are solid contents and a blending ratio is as shown in Table 2.

These solid contents were put into methyl isobutyl ketone which is a solvent and stirred to be 10% by mass. Accordingly, the coating solution HR-1 of the high-refractive-index layer 19 was produced.

The coating solution HR-1 was applied with a wire bar and a coating film was produced. In addition, the coating film was left at room temperature for 1 minute and heated at 80° C. for 2 minutes to be dried. An ultraviolet lamp (e.g., metal halide lamp, illuminance of 300 mW/cm²) was emitted for 1 second. Accordingly, the coating film may be cured. Through the above steps, the high-refractive-index layer 19 may be formed.

TABLE 2

| Type | Material name | HR-1 |
|---|---|---|
| Binder component | KAYARAD DPHA | 26.8 |
| High-refractive-index | Zirconium oxide | 70 |
| particles | (average primary particle | |
| | diameter of 10 nm) | |
| Photopolymerization initiator | IRGACURE 184 | 3 |
| Surface modifier | MEGAFACE F-568 | 0.2 |
| | Total | 100 |
| Solvent | Methyl isobutyl ketone | 100 |

| | |
|---|---|
| Refractive index | 1.70 |

* The unit is parts by mass.

[Formation of Low-Refractive-Index Layer 17]

Next, a method for producing the low-refractive-index layer 17 will be described. Herein, a coating solution of the low-refractive-index layer 17 was produced with the composition shown in Table 3.

(Coating Solution LR-1)

A coating solution LR-1 contains a monomer and/or oligomer which is the binder component and hollow silica particles 172. In addition, the coating solution LR-1 contains a photopolymerization initiator, the oil-repellent surface modifier 173, and/or the lipophilic surface modifier 173. Further, the coating solution contains a defoaming agent and a solvent. In this embodiment, OPTOOL AR-100 manufactured by Daikin Industries, Ltd. was used as a binder component. In addition, KAYARAD PET-30 manufactured by Nippon Kayaku Co., Ltd. was used as a binder component. Further, the hollow silica particles 172 having an average primary particle diameter of 75 nm were used. In addition to the hollow silica particles 172, solid silica particles having an average primary particle diameter of 10 nm were used. The solid silica particles are silica particles the inside of which is solid rather than hollow. In addition, in this embodiment, IRGACURE 184 manufactured by BASF Japan Ltd. was used as the photopolymerization initiator. As the oil-repellent surface modifier 173, KY-1203 manufactured by Shin-Etsu Chemical Co., Ltd. was used. In addition, as the lipophilic surface modifier 173, MEGAFACE RS-58 manufactured by DIC Corporation was used. Further, as the lipophilic surface modifier 173, FTERGENT 650A manufactured by NEOS COMPANY LIMITED, was used. As the defoaming agent, BYK-066N manufactured by ALTANA was used. These are solid contents and a mass blending ratio is as shown in Table 3.

These solid contents were put into a mixed solution of methyl isobutyl ketone and n-butyl alcohol, which is a solvent, and stirred. In this case, the solid content was set to 5% by mass. Accordingly, the coating solution LR-1 of the low-refractive-index layer 17 was produced. A mass blending ratio of the solvent is as shown in Table 3.

(Coating Solution LR-2)

In a coating solution LR-2, as the binder component, KAYARAD PET-30 manufactured by Nippon Kayaku Co., Ltd. was used. In addition, as the binder component, NK ester A-200 manufactured by SHIN-NAKAMURA CHEMICAL CO, LTD. was used. Hollow silica particles 172 having an average primary particle diameter of 60 nm were used. In addition to the hollow silica particles 172, solid silica particles having an average primary particle diameter 10 nm were used. In addition, as the photopolymerization initiator, IRGACURE 127 manufactured by BASF Japan Ltd. was used. As the oil-repellent surface modifier 173, KY-1203 manufactured by Shin-Etsu Chemical Co., Ltd. was used. In addition, as the lipophilic surface modifier 173, MEGAFACE RS-90 manufactured by DIC Corporation was used. As the defoaming agent, BYK-066N manufactured by ALTANA was used. These are solid contents and a mass blending ratio is as shown in Table 3.

These solid contents were put into a mixed solution of methyl isobutyl ketone and Tert-butyl alcohol, which is a solvent, and stirred. In this case, the solid content was set to 5% by mass. Accordingly, the coating solution LR-2 of the low-refractive-index layer 17 was produced. A mass blending ratio of the solvent is as shown in Table 3.

The coating solutions LR-1 and LR-2 were applied with a wire bar and a coating film was produced. In addition, the coating film was left at room temperature for 1 minute and heated at 60° C. for 3 minutes to be dried. An ultraviolet lamp (e.g., metal halide lamp, illuminance of 300 mW/cm²) was emitted for 1 second in a nitrogen gas-substituted atmosphere. Accordingly, the coating film may be cured. Through the above steps, the low-refractive-index layer 17 may be formed.

TABLE 3

| Type | Material name | LR-1 | LR-2 |
|---|---|---|---|
| Binder component | AR-100 | 20 | — |
| | KAYARAD PET-30 | 10 | 15 |
| | NK ester A-200 | — | 13 |
| Hollow silica | Average primary particle | 47.95 | — |
| particles | diameter of 75 nm | | |
| | Average primary particle | — | 47.95 |
| | diameter of 60 nm | | |
| Solid silica particles | Average primary particle | 9 | 12 |
| | diameter of 10 nm | | |
| Photopolymerization | IRGACURE 184 | 2 | — |
| initiator | IRGACURE 127 | — | 2 |
| Surface modifier | KY-1203 | 5 | 5 |
| | MEGAFACE RS-58 | 5 | — |
| | MEGAFACE RS-90 | — | 5 |
| | FTERGENT 650A | 1 | — |
| Defoaming agent | BYK-066N | 0.05 | 0.05 |
| | Total | 100 | 100 |
| Solvent | Methyl isobutyl ketone | 70 | 30 |
| | n-butyl alcohol | 30 | — |
| | Tert-butyl alcohol | — | 70 |

| | | |
|---|---|---|
| Refractive index | 1.30 | 1.31 |

* The unit is parts by mass.

[Configuration of Resin Film]

Next, a combination of the anisotropic diffusion layer 16, the hard coating layer 18, the high-refractive-index layer 19, and the low-refractive-index layer 17 described above will be described. Herein, in this order, each of these layers was produced on the base material 15 as a combination shown in Tables 4 to 6. However, as shown in Tables 4 to 6, at least one of the layers may not be produced.

### EXAMPLE 1

In Example 1, as shown in Table 4, the anisotropic diffusion layer AD-1 was produced on the base material 15 as the anisotropic diffusion layer 16. The hard coating layer 18 was produced on the anisotropic diffusion layer 16 using the coating solution HC-1. The low-refractive-index layer 17 was produced on the hard coating layer 18 using the coating solution LR-1. In Example 1, the high-refractive-index layer 19 was formed.

### Examples 2 to 12

In Examples 2 to 12, each layer constituting the resin film was produced with a combination of the anisotropic diffusion layer or the coating solution shown in Tables 4 and 5.

Example 2 is a case where the anisotropic diffusion layer AD-2 was used rather than the anisotropic diffusion layer AD-1, as compared to Example 1. Example 2 is a case where the anisotropic particles 162 having a size near the upper limit in a preferable range were used.

Example 3 is a case where the anisotropic diffusion layer AD-3 was used rather than the anisotropic diffusion layer AD-1, as compared to Example 1. Example 3 is a case where the anisotropic particles 162 having a size near the lower limit in a preferable range were used. Example 3 is a case where the anisotropic particles 162 having an aspect ratio near the lower limit in a preferable range were used.

Example 4 is a case where the high-refractive-index layer 19 was produced using the coating solution HR-1, as compared to Example 1.

Example 5 is a case where the hard coating layer 18 was not produced, as compared to Example 1.

Example 6 is a case where the hard coating layer 18 was produced using the coating solution HC-2, as compared to Example 1.

Examples 7 to 11 are cases where the anisotropic diffusion layers AD-4 to AD-8 were used, respectively, as compared to Example 1. Among these, in Examples 7 (AD-4) to 9 (AD-6), the kind of the anisotropic particles 162 is changed, as compared to Example 1. In Examples 10 and 11, at least one of the size and the aspect ratio of the anisotropic particles 162 is not in a more preferable range.

Example 12 is a case where the anisotropic diffusion layer AD-9 also functions as the base material 15, as compared to Example 1. In this example, the anisotropic particles 162 and the resin portion 161 are compatible.

### Comparative Examples 1 to 5

In Comparative Examples 1 to 5, each layer was produced with a combination of the anisotropic diffusion layer and the isotropic diffusion layer, and the coating solution shown in Table 6.

Among these, Comparative Example 1 is a case where the anisotropic particles 162 are not included, as compared to Example 1.

Comparative Examples 2 and 3 are cases where an isotropic diffusion layer was formed rather than an anisotropic diffusion layer, as compared to Example 1. That is, in Comparative Examples 2 and 3, the isotropic diffusion layer ID-1 and the isotropic diffusion layer ID-2 were formed, respectively.

Comparative Example 4 is a case where the reflectivity of the anisotropic diffusion layer AD-10, excluding the specular reflection light component, is not equal to or less but exceeds 1.0%, as compared to Example 1.

Comparative Example 5 is a case where the low-refractive-index layer 17 was not produced, as compared to Example 1.

TABLE 4

| | | Ex- | Ex- | Ex- | Ex- | Ex- | Ex- |
|---|---|---|---|---|---|---|---|
| | | ample | ample | ample | ample | ample | ample |
| | | 1 | 2 | 3 | 4 | 5 | 6 |
| Coat- | Base | TAC | TAC | TAC | TAC | TAC | TAC |
| ing | material | | | | | | |
| sol- | Aniso- | AD-1 | AD-2 | AD-3 | AD-1 | AD-1 | AD-1 |
| ution | tropic | | | | | | |
| | diffusion | | | | | | |
| | layer | | | | | | |
| | Hard | HC-1 | HC-1 | HC-1 | HC-1 | — | HC-2 |
| | coating | | | | | | |
| | layer | | | | | | |
| | High- | — | — | — | HR-1 | — | — |
| | refractive- | | | | | | |
| | index | | | | | | |
| | layer | | | | | | |
| | Low- | LR-1 | LR-1 | LR-1 | LR-1 | LR-2 | LR-1 |
| | refractive- | | | | | | |
| | index | | | | | | |
| | layer | | | | | | |
| Film | Base | 60 μm | 60 μm | 60 μm | 60 μm | 60 μm | 60 μm |
| thick- | material | | | | | | |
| ness | Aniso- | 10 μm | 10 μm | 10 μm | 10 μm | 10 μm | 10 μm |
| | tropic | | | | | | |
| | diffusion | | | | | | |
| | layer | | | | | | |
| | Hard | 5 μm | 5 μm | 5 μm | 5 μm | — | 5 μm |
| | coating | | | | | | |
| | layer | | | | | | |
| | High- | — | — | — | 146 nm | — | — |
| | refractive- | | | | | | |
| | index | | | | | | |
| | layer | | | | | | |
| | Low- | 100 nm | 100 nm | 100 nm | 98 nm | 100 nm | 100 nm |
| | refractive- | | | | | | |
| | index | | | | | | |
| | layer | | | | | | |
| Eval- | SCE of | 0.40% | 0.48% | 0.70% | 0.40% | 0.40% | 0.40% |
| uative | aniso- | | | | | | |
| result | tropic | | | | | | |
| | diffusion | | | | | | |
| | layer | | | | | | |
| | ADV of | 30 | 20 | 26 | 30 | 30 | 30 |
| | aniso- | | | | | | |
| | tropic | | | | | | |
| | diffusion | | | | | | |
| | layer | | | | | | |
| | Haze | 45% | 45% | 50% | 45% | 45% | 45% |
| | value of | | | | | | |
| | aniso- | | | | | | |
| | tropie | | | | | | |
| | diffusion | | | | | | |
| | layer | | | | | | |
| | SCI of | 0.65% | 0.71% | 0.99% | 0.58% | 0.69% | 0.60% |
| | resin film | | | | | | |
| | Front | A | A | A | A | A | A |
| | luminance | | | | | | |
| | of resin | | | | | | |
| | film | | | | | | |
| | Front | A | A | A | A | A | A |
| | contrast of | | | | | | |
| | resin film | | | | | | |
| | 60° | A | A | A | A | A | A |
| | luminance | | | | | | |
| | of resin | | | | | | |
| | film | | | | | | |
| | Reflection | A | A | A | A | A | A |
| | on display | | | | | | |

TABLE 5

| | | Ex- | Ex- | Ex- | Ex- | Ex- | Ex- |
|---|---|---|---|---|---|---|---|
| | | ample | ample | ample | ample | ample | ample |
| | | 7 | 8 | 9 | 10 | 11 | 12 |
| Coat- | Base | TAC | TAC | TAC | TAC | TAC | — |
| ing | material | | | | | | |
| sol- | Aniso- | AD-4 | AD-5 | AD-6 | AD-7 | AD-8 | AD-9 |
| ution | tropic | | | | | | |
| | diffusion | | | | | | |
| | layer | | | | | | |
| | Hard | HC-1 | HC-1 | HC-1 | HC-1 | HC-1 | HC-1 |
| | coating | | | | | | |
| | layer | | | | | | |
| | High- | — | — | — | — | — | — |
| | refractive- | | | | | | |
| | index layer | | | | | | |
| | Low- | LR-1 | LR-1 | LR-1 | LR-1 | LR-1 | LR-1 |
| | refractive- | | | | | | |
| | index layer | | | | | | |
| Film | Base | 60 μm | 60 μm | 60 μm | 60 μm | 60 μm | — |
| thick- | material | | | | | | |
| ness | Aniso- | 10 μm | 10 μm | 10 μm | 10 μm | 10 μm | 60 μm |
| | tropic | | | | | | |
| | diffusion | | | | | | |
| | layer | | | | | | |
| | Hard | 5 μm | 5 μm | 5 μm | 5 μm | 5 μm | 5 μm |
| | coating | | | | | | |
| | layer | | | | | | |
| | High- | — | — | — | — | — | — |
| | refractive- | | | | | | |
| | index layer | | | | | | |
| | Low- | 100 nm | 100 nm | 100 nm | 100 nm | 100 nm | 100 nm |
| | refractive- | | | | | | |
| | index layer | | | | | | |
| Eval- | SCE of | 0.39% | 0.97% | 0.53% | 0.98% | 0.98% | 0.50% |
| uative | anisotropic | | | | | | |
| result | diffusion | | | | | | |
| | layer | | | | | | |
| | ADV of | 15 | 12 | 8 | 7 | 6 | 25 |
| | anisotropic | | | | | | |
| | diffusion | | | | | | |
| | layer | | | | | | |
| | Haze | 39% | 22% | 44% | 25% | 30% | 49% |
| | value of | | | | | | |
| | anisotropic | | | | | | |
| | diffusion | | | | | | |
| | layer | | | | | | |
| | SCI of | 0.63% | 1.33% | 0.82% | 1.29% | 1.31% | 0.70% |
| | resin film | | | | | | |
| | Front | A | B | A | B | B | A |
| | luminance | | | | | | |
| | of resin | | | | | | |
| | film | | | | | | |
| | Front | A | B | A | B | B | A |
| | contrast of | | | | | | |
| | resin film | | | | | | |
| | 60° | A | B | B | B | B | A |
| | luminance | | | | | | |
| | of resin | | | | | | |
| | film | | | | | | |
| | Reflection | A | B | B | B | B | A |
| | on display | | | | | | |

TABLE 6

| | | Com- | Com- | Com- | Com- | Com- |
|---|---|---|---|---|---|---|
| | | parative | parative | parative | parative | parative |
| | | Example | Example | Example | Example | Example |
| | | 1 | 2 | 3 | 4 | 5 |
| Coating | Base | TAC | TAC | — | — | TAC |
| solution | material | | | | | |
| | Aniso- | — | ID-1 | ID-2 | AD-10 | AD-1 |
| | tropic | | | | | |
| | diffusion | | | | | |
| | layer | | | | | |
| | Hard | HC-3 | HC-1 | HC-1 | HC-1 | — |
| | coating | | | | | |
| | layer | | | | | |
| | High- | — | — | — | — | — |
| | refractive- | | | | | |
| | index | | | | | |
| | layer | | | | | |
| | Low- | LR-1 | LR-1 | LR-1 | LR-1 | — |
| | refractive- | | | | | |
| | index | | | | | |
| | layer | | | | | |
| Film | Base | 60 μm | 60 μm | — | — | 60 μm |
| thick- | material | | | | | |
| ness | Aniso- | — | 10 μm | 60 μm | 60 μm | 10 μm |
| | tropic | | | | | |
| | diffusion | | | | | |
| | layer | | | | | |
| | Hard | 5 μm | 5 μm | 5 μm | 5 μm | — |
| | coating | | | | | |
| | layer | | | | | |
| | High- | — | — | — | — | — |
| | refractive- | | | | | |
| | index | | | | | |
| | layer | | | | | |
| | Low- | 100 nm | 100 nm | 100 nm | 100 nm | — |
| | refractive- | | | | | |
| | index | | | | | |
| | layer | | | | | |
| Eval- | SCE of | — | 0.41% | 0.29% | 1.40% | 0.40% |
| uative | aniso- | | | | | |
| result | tropic | | | | | |
| | diffusion | | | | | |
| | layer | | | | | |
| | ADV of | — | 1.2 | 1.1 | 31 | — |
| | aniso- | | | | | |
| | tropic | | | | | |
| | diffusion | | | | | |
| | layer | | | | | |
| | Haze | — | 30% | 50% | 81% | 50% |
| | value of | | | | | |
| | aniso- | | | | | |
| | tropic | | | | | |
| | diffusion | | | | | |
| | layer | | | | | |
| | SCI of | 0.44% | 0.69% | 0.58% | 1.73% | 5.69% |
| | resin film | | | | | |
| | Front | A | C | C | C | B |
| | luminance | | | | | |
| | of resin | | | | | |
| | film | | | | | |
| | Front | A | C | D | C | B |
| | contrast | | | | | |
| | of resin | | | | | |
| | film | | | | | |
| | 60° | D | C | C | B | A |
| | luminance | | | | | |
| | of resin | | | | | |
| | film | | | | | |
| | Reflection | A | B | A | D | D |
| | on | | | | | |
| | display | | | | | |

[Evaluation Method]

For Examples 1 to 12 and Comparative Examples 1 to 5, the following items were evaluated.

(Film Thickness and Refractive Index)

The film thickness of each layer constituting the resin film was measured. In addition, the refractive indexes of the hard coating layer 18, the high-refractive-index layer 19, and the low-refractive-index layer 17 constituting the resin film were measured.

The film thickness and the refractive index were measured using a spectroscopic ellipsometer (VUV-VASE) manufactured by J. A. Woollam. In this case, the measurement was performed in the same sample by setting n as 3 and an average value was used.

(SCI Reflectivity and SCE Reflectivity)

The SCI reflectivity (reflectivity specular reflection light) of the resin film and the SCE reflectivity (reflectivity excluding specular reflection light component) of the anisotropic diffusion layer 16 were measured.

The SCI reflectivity and the SCE reflectivity were measured using CM-2600d manufactured by Konica Minolta, Inc. The measurement was performed after bonding a black PET film to a rear surface of a measurement film. A smaller SCI reflectivity is considered as a good result. It is necessary that the SCI reflectivity is 1.0% or less.

(Haze Value)

A haze value of the isotropic diffusion layer 16 was measured. The haze value was measured using a haze meter NDH5000W manufactured by NIPPON DENSHOKU INDUSTRIES Co., Ltd. In this case, the measurement was performed in the same sample by setting n as 3 and an average value was used.

(ADV)

The anisotropic diffusivity (ADV) of the anisotropic diffusion layer 16 was measured. The ADV was measured using a goniophotometer GP-200 manufactured by MURAKAMI COLOR RESEARCH LABORATORY CO., LTD.

A sample was disposed so that the incident light is perpendicular to a sample surface, and luminance distributions of the transmitted light in the anisotropic diffusion direction and the perpendicular direction were measured. The luminance distribution was measured in a range of −50° to +50°. A ratio of the amount of the transmitted light at 5° in the anisotropic diffusion direction and the amount of the transmitted light at 5° in the direction perpendicular to the anisotropic diffusion direction was defined as ADV.

(Viewing Angle Characteristics)

As the viewing angle characteristics, a front luminance, a front contrast, and 60° luminance were measured. These were measured using ConoScope manufactured by Autronic Merucias. After attaching the produced sample onto a VA panel so that the diffusion direction is a width direction of the display, the luminance distribution in the display width direction in a case of black display (gradation 0) and white display (gradation 255) was measured. The luminance distribution was measured in a range of −80° to +80°. For the 60° luminance, an average value of luminance of −60° to +60° was used. In addition, the luminance of a front surface (0°) during white display was measured as front luminance. Further, a ratio of the luminance of the front surface during the white display to the luminance of the front surface during the black display was set as the front contrast.

The evaluation in this case was performed as below.

When the front luminance was 400 cd/m² or more, it was evaluated as “A,” when the front luminance was 350 cd/m² or more and less than 400 cd/m², it was evaluated as “B,” when the front luminance was 300 cd/m² or more and less than 350 cd/m², it was evaluated as “C,” and when the front luminance was less than 300 cd/m², it was evaluated as “D”.

Additionally, when the front contrast was 3000 or more, it was evaluated as “A,” when the front contrast was 2300 or more and less than 3000, it was evaluated as “B,” when the front contrast was 1800 or more and less than 2300, it was evaluated as “C,” and when the front contrast was less than 1800, it was evaluated as “D”.

Additionally, when the 60° luminance was 30% or more, it was evaluated as “A,” when the 60° luminance was 23% or more and less than 30%, it was evaluated as “B,” when the 60° luminance was 18% or more and less than 23%, it was evaluated as “C,” and when the 60° luminance was less than 18%, it was evaluated as “D”.

The case of A or B was evaluated as acceptable and the case of C or D was evaluated as unacceptable.

(Reflection on Display)

After bonding the sample to the display using an adhesive film, the reflection of external light on a screen when turning the display on was measured visually.

The evaluation in this case was performed as below.

When the reflection of the external light was extremely slight and visibility of the image is excellent, it was evaluated as “A,” when the reflection of the external light could be observed to some degree and the effect on the visibility of the image is slight, it was evaluated as “B,” when the reflection of the external light is noticed in many cases and a deterioration in visibility of the image could be observed, it was evaluated as “C,” and when the reflection of the external light is significant and the visibility of the image is poor, it was evaluated as “D”. The case of A or B was evaluated as acceptable and the case of C or D was evaluated as unacceptable.

[Evaluation Results]

The evaluation results are shown in Tables 4 to 6. The refractive indexes of the hard coating layer 18, the high-refractive-index layer 19, and the low-refractive-index layer 17 are shown in Tables 1 to 3.

As shown in Table 3, the refractive index of the low-refractive-index layer 17 was 1.40 or less, which was an excellent result.

As shown in Tables 4 and 5, in Examples 1 to 12, the SCE reflectivity was 1.0% or less, which was an excellent result.

In Examples 1 to 7, the needle-shaped calcium carbonate particles or basic magnesium sulfate fiber were used as the anisotropic particles 162. In addition, both the size and the aspect ratio of the anisotropic particles 162 are in the more preferable range. That is, the anisotropic particles 162 have the length in the short direction of 0.1 μm to 10 μm. In addition, the anisotropic particles 162 have aspect ratios of the length in the longitudinal direction to the length of the short direction of 10 or greater. In the case of Examples 1 to 7, all of the front luminance, the front contrast, and the 60° luminance which are viewing angle characteristics, were evaluated as A. In addition, all of the reflection on the display was evaluated as A.

In Example 8, the needle-shaped titanium oxide particles were used as the anisotropic particles 162. In addition, in Example 9, the glass long fiber was used as the anisotropic particles 162. In this case, the viewing angle characteristics and the reflection on the display were evaluated as A or B which was in the acceptable range.

In Examples 10 and 11, at least one of the size and the aspect ratio of the anisotropic particles 162 is beyond the more preferable range. In this case, all of the viewing angle characteristics and the reflection on the display were evaluated as B, which was in the acceptable range.

In Example 12, the anisotropic particles 162 and the resin portion 161 are compatible. In this case, all of the viewing angle characteristics and the reflection on the display were evaluated as A.

In Comparative Example 1, the anisotropic particles 162 are not contained. In this case, the 60° luminance was evaluated as D, which was unacceptable.

In Comparative Examples 2 and 3, the isotropic diffusion layer is used rather than using the anisotropic diffusion layer. In this case, the front luminance, the front contrast, and the 60° luminance were evaluated as C or D, which was unacceptable.

In Comparative Example 4, the reflectivity excluding the specular reflection light component is not 1.0% or less but exceeds 1.0%. In this case, the front luminance, the front contrast, and the reflection on the display were evaluated as C or D, which is unacceptable.

In Comparative Example 5, the low-refractive-index layer 17 was not provided. In this case, the reflection on the display was evaluated as D, which was acceptable.

In addition, compared to Example 1, a film in which the position of the anisotropic diffusion layer 16 was changed to a rear surface of the base material 15 (TAC) was produced and the same evaluation was performed. As a result, it was observed that the performance equivalent to that in Example 1 could be ensured.

Through the above results, it is found that improved characteristics (e.g., increased visibility, suppressed reflection) of the display may be achieved using the anisotropic diffusion layer 16, and the low-refractive-index layer 17 having a refractive index of 1.40 or less in the resin film. In addition, it is found that improvements are achieved with the reflectivity excluding the specular reflection light component being 1.0% or less.

### SEQUENCE LIST FREE TEXT

1 . . . display, 1a . . . liquid crystal panel, 11 . . . backlight, 12, 12a, 12b . . . polarizing film, 13, 13a, 13b . . . retardation film, 14 . . . liquid crystal, 15 . . . base material, 16 anisotropic diffusion layer, 17 . . . low-refractive-index layer, 18 hard coating layer, 19 . . . high-refractive-index layer, 161 . . . resin portion, 162 . . . anisotropic particles

What is claimed is:

1. A resin film comprising:
a low-refractive-index layer having a refractive index of 1.40 or less; and
an anisotropic diffusion layer configured to diffuse light anisotropically,
wherein the anisotropic diffusion layer comprises anisotropic particles having an anisotropic shape, the anisotropic particles having a longitudinal direction aligned along one direction, and a resin portion which diffuses the anisotropic particles and is formed of a resin, and
wherein a reflectivity excluding a specular reflection light component is 1.0% or less.

2. The resin film according to claim 1, wherein the anisotropic particles have a refractive index in the longitudinal direction and a refractive index in a short direction different from each other.

3. The resin film according to claim 2, wherein at least one of the following relationships (I) and (II) is satisfied, where a refractive index of the resin portion is defined as n_{b}, a refractive index of the anisotropic particles in the longitudinal direction is defined as nₐₓ, and a refractive index of the anisotropic particles in the short direction is defined as n_{ay}:

|n_{b}−nₐₓ|<0.04 and 0.04<|n_{b}−n_{ay}|<0.50; (I)

|n_{b}−n_{ay}|<0.04 and 0.04<|n_{b}−nₐₓ|<0.50. (II)

4. The resin film according to claim 1, wherein the anisotropic particles have a length in the longitudinal direction of 1 μm to 200 μm and a length in a short direction of 0.1 μm to 10 μm.

5. The resin film according to claim 4, wherein an aspect ratio which is a ratio of the length of the anisotropic particles in the longitudinal direction to the length in the short direction is 10 or more.

6. The resin film according to claim 1, wherein an interface between the anisotropic particles and the resin portion is compatible.

7. The resin film according to claim 1, wherein a refractive index of the resin portion is 1.45 to 1.65.

8. The resin film according to claim 1, wherein the anisotropic particles contain at least one of metal oxide, a carbonate compound, a hydroxide compound, or a phosphate compound.

9. The resin film according to claim 1, wherein a difference in refractive index of the resin portion and the low-refractive-index layer is 0.1 or more.

10. The resin film according to claim 1, wherein the anisotropic diffusion layer has a haze value of 20% to 80%.

11. The resin film according to claim 1, wherein the anisotropic diffusion layer has an anisotropic diffusivity of 3 or more.

12. The resin film according to claim 1, further comprising:
a high-refractive-index layer having a refractive index of 1.60 or more.

13. The resin film according to claim 1, further comprising:
a hard coating layer having a refractive index of 1.54 or more.

14. The resin film according to claim 1, further comprising:
a base material which supports the low-refractive-index layer and the anisotropic diffusion layer,
wherein the base material is provided between the low-refractive-index layer and the anisotropic diffusion layer.

15. The resin film according to claim 1, wherein the anisotropic diffusion layer functions as a base material which supports the low-refractive-index layer.

16. A method of making a resin film, the method comprising:
forming a low-refractive-index layer having a refractive index of 1.40 or less; and
forming an anisotropic diffusion layer configured to diffuse light anisotropically,
wherein the anisotropic diffusion layer comprises anisotropic particles having an anisotropic shape, the anisotropic particles having a longitudinal direction aligned along one direction, and a resin portion which diffuses the anisotropic particles and is formed of a resin, and
wherein a reflectivity excluding a specular reflection light component is 1.0% or less.

17. The method of claim 16, wherein the anisotropic layer is formed by stretching.

18. The method of claim 16, wherein the formation of at least one of the anisotropic layer and the low-refractive-index layer comprises:
preparing a coating solution;
applying the coating solution to form a coating film;
drying the coating film; and
polymerizing the coating film.

19. The method of claim 18, wherein the step of polymerizing the coating film comprises applying at least one of ultraviolet light or heat.

20. The method of claim 16, further comprising:
providing a base material and arranging the base material between the low-refractive-index layer and the anisotropic layer.
